(19) United States
(12) Patent Application Publication
(10) Pub. No.: US 2018/0108464 A1
(43) Pub. Date: Apr. 19, 2018

(54) SINTERED BODY FOR FORMING RARE-EARTH MAGNET, AND RARE-EARTH SINTERED MAGNET

(71) Applicant: NITTO DENKO CORPORATION, Osaka (JP)

(72) Inventors: Kenichi FUJIKAWA, Osaka (JP); Takashi YAMAMOTO, Osaka (JP); Hirofumi EBE, Osaka (JP); Makoto FUJIHARA, Osaka (JP); Eiichi IMOTO, Osaka (JP); Tomohiro OMURE, Osaka (JP)

(21) Appl. No.: 15/559,654

(22) PCT Filed: Mar. 24, 2016
(86) PCT No.: PCT/JP2016/059394

§ 371 Date: Nov. 15, 2017

(30) Foreign Application Priority Data
Mar. 24, 2015 (JP) 2015-061080
Mar. 24, 2015 (JP) 2015-061081
Jun. 18, 2015 (JP) 2015-122734
Jul. 31, 2015 (JP) 2015-151764
Feb. 9, 2016 (JP) 2016-022770
Mar. 1, 2016 (JP) 2016-039115
Mar. 1, 2016 (JP) 2016-039116

(51) Int. Cl. H01F 1/053; C22C 38/16; C22C 38/00; C22C 38/12; C22C 38/10; C22C 38/06; B22F 1/00

(52) U.S. Cl. CPC H01F 1/0536; C22C 38/16; C22C 38/005; C22C 38/12; B22F 2304/10; C22C 38/06; B22F 1/0062; B22F 2301/355; C22C 38/10

(57) ABSTRACT

Provided are: a sintered body that forms a rare-earth magnet and is configured in a manner such that the divergence between the orientation angles of the easy axes of magnetization of magnet material particles and the orientation axis angle of the magnet material particles is kept within a prescribed range in an arbitrary micro-section of a magnet cross-section; and a rare-earth sintered magnet. This sintered body for forming a rare-earth magnet has two or more different regions exhibiting an orientation axis angle of at least 20°, given that the orientation axis angle is defined as the highest-frequency orientation angle among the orientation angles of the easy magnetization axes, relative to a pre-set reference line, of a plurality of magnet material particles in a rectangular section at an arbitrary position in a plane including the thickness direction and the widthwise direction.

### TECHNICAL FIELD

The present invention relates to a sintered body for forming a rare-earth magnet and a rare-earth magnet obtained by magnetizing the sintered body. More particularly, the present invention relates to a rare-earth magnet-forming sintered body having a structure in which magnet material particles including rare-earth materials and each having an easy magnetization axes are integrally sintered, and a rare-earth magnet obtained by magnetizing the sintered body.

### BACKGROUND ART

A rare-earth magnet has been recognized and put into practical use as a high performance permanent magnet since a high coercivity and residual flux density can be expected. In view of the situation, efforts are now continued for a still further development to obtain a further improvement. For example, in an article in the Journal of the Japan Society of Metallurgy, Vol. 76, No. 1, pp 12 to 16, by Yasuhiro UNE entitled “Enhancement of Coercivitv in Nd—Fe—B Based Sintered Magnet through use of Finer Crystal Particles” (Non-Patent Document 1), describes, based on the recognition that it has been well known that the coercivity of a magnet can be increased by decreasing particle size of magnet materials, an example wherein magnet-forming material particles of an average particle size of 1 μm are used for manufacturing a rare-earth sintered magnet in order to increase the coercivity of an Nd—Fe—B type sintered magnet. In the method for manufacturing a rare-earth sintered magnet described in the non-patent document 1, a mixture of magnet material particles and a lubricant comprising a surface reactant is charged in a carbon mold which is fixed in a hollow core coil, and a pulsating magnetic field is applied to have the magnet material particles oriented. However, with this method, the orientation of the magnet material particle is determined only by the pulsating magnetic field applied by the hollow core coil, so that it is impossible to obtain a permanent magnet having magnet material particles oriented in any desired direction in different positions in the magnet. Further, the non-patent document 1 does not contain any consideration as to how or to what extent the easy magnetization axes of the magnet material particles are deviated from intended directions, how the deviation will affect the magnet performance.

JP H6-302417A (Patent Document 1) discloses a method of producing a permanent magnet having a plurality of regions wherein magnet materials in respective regions have easy magnetization axes oriented respectively different directions. According to the method disclosed in the patent document 1, a plurality of magnet bodies having easy magnetization axes of magnet material particles respectively oriented in different directions are joined together in producing rare-earth permanent magnet including a rare-earth element R, Fe and B as basic constituent elements. The method described in the patent document 1 makes it possible to produce a rare-earth permanent magnet including a plurality of regions having easy magnetization axes of magnet material particles oriented respectively in desired different directions in respective regions. However, the patent document 1 does not describe anything about possible deviations of the actual orientations in respective magnet material particles from desired directions of orientations in respective regions.

JP 2006-222131A (Patent Document 2) discloses a method for producing an annular rare-earth permanent magnet by arranging and connecting an even number of permanent magnets in a circumferential direction. According to the method for producing rare-earth permanent magnet described in the patent document 1, a sector-shaped permanent magnet piece having a pair of sector-shaped major surfaces and a pair of side surfaces is formed in a particle pressing apparatus having a correspondingly sector-shaped cavity. In the method, particles of rare-earth alloy are charged in the sector-shaped cavity and pressed by a pair of punches which are provided with orienting coils while orienting magnetic field is being applied to the particles of the magnetic materials. With this process, there is produced a permanent magnet piece having a radial anisotropy between N pole and S pole on the respective major surfaces. Specifically, it is possible to produce a permanent magnet having an orientation of magnetization with a magnetization direction curved in an arcuate configuration from a corner wherein one of the major surface intersects with one of the side surfaces toward the other major surface and from the other major surface toward a corner wherein the one major surface intersects with the other of the side surfaces. A plurality of such permanent magnet having radial anisotropy in magnetization direction are joined to form an annular shape such that the each two adjacent permanent magnet pieces have mutually opposite polarity.

The patent document 2 further discloses an arrangement of magnet pieces wherein magnet pieces having axial orientation of magnetization and those having radial orientation of magnetization are alternately arranged. There is described that, with this arrangement, it is possible to have magnetic flux concentrated in the pole of one major surface of one axially magnetized magnet piece and further have the magnetic flux from the pole of the one magnet piece efficiently converged to one major surface of the other axially magnetized magnet piece, by arranging the axially magnetized magnet pieces and the radially magnetized magnet pieces such that the alternately arranged axially magnetized magnet pieces have opposite polarity at the major surfaces, and the radially magnetized magnet piece between the two axially magnetized magnet pieces has polarity identical with the opposed polarity in the adjacent axially magnetized magnet piece. However, the patent document 2 does not describe anything about possible deviations of the actual orientations in respective magnet material particles from desired directions of orientations.

JP 2015-32669A (Patent Document 3) and JP H6-244046A (Patent Document 4) both disclose a method for forming a rare-earth permanent magnet having radial orientation of magnet material particles. The method comprises steps of press forming magnet material particles containing rare-earth elements R, Fe and B to form a flat panel pressed body, applying parallel magnetic field to the pressed body to effect orientation under a magnetic field, sintering at a sintering temperature to form a sintered magnet, then press forming the sintered magnet into an arcuate shape under a temperature condition with a die having an arcuate pressing portion. Both the patent documents 3 and 4 disclose a method for forming a magnet having a radially oriented magnet material particles by using a parallel magnetic field, however, since the press forming process for bending the flat panel shape to the arcuate shape is conducted after the sintering step, there will be difficulty in such forming so that it will be impossible to apply the step to a process for producing a large or a complicated deformation. Therefore, the process taught by either the patent document 3 or patent document 4 is limited to that for forming a magnet having a radial orientation as disclosed in the documents. The patent documents 3 and 4 do not describe anything about possible deviations of the actual orientations in respective magnet material particles from desired directions of orientations.

JP5444630B (Patent Document 5) discloses a flat panel-shaped permanent magnet for use in an embedded magnet type motor. The permanent magnet disclosed in the patent document 5 has a radial orientation of easy magnetization axes wherein inclination angles of the easy magnetization axes in a cross-section of the magnet continuously change from widthwise opposite end portions to a widthwise central portion. More specifically, the easy magnetization axes of the magnet are oriented such that they converge to one point on an imaginary line extending in a cross-section of the magnet from the central portion in a thickness direction. As regards a method for producing such a permanent magnet having a radial orientation of the easy magnetization axes, the patent document 5 describes that it is readily possible to produce such magnet with application of a magnetic field which can be easily applied during shaping of the magnet. The method taught by the patent document 5 is to apply a magnetic field which is converged to one point located externally of the magnet during shaping of the magnet, so that the method is limited to a manufacture of a magnet having radially oriented easy magnetization axes. Therefore, the method cannot produce a magnet having a different orientation pattern, such as a magnet having an orientation wherein the easy magnetization axes are oriented in parallel each other in a widthwise central region along a direction of the thickness, but oriented obliquely in widthwise end regions. Further, the patent document 5 does not describe anything about possible deviations of the actual orientations in respective magnet material particles from desired directions of orientations.

JP 2005-44820A (Patent Document 6) discloses a method for producing a rare-earth sintered ring-shaped magnet having an anisotropy polarity which is substantially free of cogging torque when it is incorporated in a motor. The rare-earth sintered ring-shaped magnet is magnetized such that it has magnetic poles at a plurality of circumferentially spaced apart positions, and a radially oriented direction of magnetization in the position of the magnetic pole but circumferentially oriented direction of magnetization in a position between each two adjacent magnetic poles. The method for producing a rare-earth sintered ring-shaped magnet described in the patent document 6 is limited to a manufacture of a magnet having an anisotropy polarity, but it cannot produce a magnet having different directions of orientation in any different regions of the magnet. Further, the patent document 6 does not describe anything about possible deviations of the actual orientations in respective magnet material particles from desired directions of orientations.

JP 2000-208322A (Patent Document 7) discloses a panel-like, sector-shaped one-piece permanent magnet having different orientations of magnet material particles in a plurality of regions. According to the patent document 7, a permanent magnet is formed with a plurality of regions, wherein in one of the regions, the magnet material particles are oriented in pattern parallel with a direction of thickness, but in a region adjacent to the one region, the magnet material particles are oriented with an angle with respect to the orientation of the magnet material particles in the one region. The patent document 7 describes that a permanent magnet having the aforementioned orientation of the magnet material particles can be produced by adopting a powder metallurgy and die forming under pressing force through application of a magnetic field in an appropriate direction. However, the method for forming a permanent magnet described in the patent document 7 is only applicable to a production method of a magnet having a specific orientation direction. Further, the patent document 6 does not describe anything about possible deviations of the actual orientations in respective magnet material particles from desired directions of orientations.

WO 2007/119393 (Patent Document 8) discloses a method for manufacturing a permanent magnet having non-parallel orientation of magnet material particles, by forming a mixture of magnet material particles and a binder into a desired shape to produce a shaped body, applying a parallel magnetic field to the shaped body to produce parallel orientation of the magnet material particles, and deforming the shaped body into a different shape to change the orientation of the magnet material particles into a different pattern. The magnet disclosed in the patent document 8 is a so-called bond magnet wherein the magnet material particles are bonded together by the binder composition, and is not a sintered magnet. A bond magnet is of a structure wherein a plastic material is interposed between the magnet material particles so that it has a magnetic property inferior to that of a sintered magnet. Thus, the method cannot produce a high performance magnet.

JP 2013-191612A (Patent Document 9) discloses a method for forming a rare-earth sintered magnet comprising steps of forming a mixture of magnet material particles and a binder into a sheet configuration to form a green sheet, applying a magnetic field to the green sheet to carry out an orienting process under a magnetic field, subjecting the oriented green sheet to a calcination treatment to dissolve and dissipate the plastic binder, and sintering the sheet under a sintering temperature. The sintered magnet produced by the method described in the patent document 9 has a structure wherein the easy magnetization axes are oriented in one direction, so that the method cannot produce a magnet one-piece permanent magnet having different orientations of magnet material particles in a plurality of regions. Further, the patent document 9 does not describe anything about possible deviations of the actual orientations in respective magnet material particles from desired directions of orientations.

### CITATION LIST

### Parent Document

Patent Document 1: JP H6-302417A
Patent Document 2: JP 2006-222131A
Patent Document 3: JP 2015-32669A
Patent Document 4: JP H6-244046A
Patent Document 5: JP5444630B
Patent Document 6: JP 2005-44820A
Patent Document 7: JP 2000-208322A
Patent Document 8: WO 2007/119393
Patent Document 9: JP 2013-191612A
Patent Document 10: U.S. Pat. No. 5,705,902
Patent Document 11: JP 2013-215021A
Non-Patent Document 1: The Japan Society of Metallurgy, Vol. 76, No. 1, pp 12 to 16, by Yasuhiro UNE entitled “Enhancement of Coercivity in Nd—Fe—B Based Sintered Magnet through use of Finer Crystal Particles”

### SUMMARY OF INVENTION

### Technical Problem

As described above, anyone of the patent documents and the non-patent document does not describe anything about possible deviations of the actual orientations in respective magnet material particles from desired directions of orientations. The inventors have made a research on deviations under a definition described later of the actual orientations in respective magnet material particles from desired directions of orientations in rare-earth permanent magnets described in the aforementioned documents and those actually produced and available in market, and confirmed that the deviation is larger than 16° in all investigated magnets. It should be noted that, in a case where a plurality of magnet material particles contained in an infinitesimal area in a section of a magnet have easy magnetization axes are oriented in directions deviated from their desired directions, the performance of the magnet will become lower as the amount of deviation becomes larger.

Thus, it is a primary object of the present invention is to provide a rare-earth magnet-forming sintered body and a rare-earth sintered magnet in which a deviation of orientation angle of easy magnetization axes of each magnet material particle with respect to a defined axis orientation angle of magnet material particles in any infinitesimal area in a section of magnet is maintained within a predefined range. In other words, the present invention is intended to provide a new rare-earth sintered magnet having a highly accurate magnet material particle orientation which has not ever existed in the past, and a sintered body for producing such magnet. More specifically, the present invention provides a sintered body for forming a rare-earth sintered magnet including at least two regions having defined axis orientation angles which are different each other by 20° or more, wherein, in any infinitesimal area in a section of the magnet, a deviation of orientation angle of easy magnetization axis of each magnet material particle with respect to the defined axis orientation angle is maintained within a predetermined range. The present invention also provides a rare-earth sintered magnet produced from the sintered body.

### Solution to Technical Problem

In order to accomplish the above object, in a first aspect, the present invention provides a rare-earth magnet-forming sintered body wherein a number of magnet material particles including rare-earth substances and each having an easy magnetization axis are integrally sintered. The sintered body is of a parallelepiped three dimensional shape which has a lengthwise dimension in a lengthwise direction, a thickness dimension defined between a first surface and a second surface in a thickness direction in a section perpendicular to the lengthwise direction, and a cross-thickness dimension taken in a cross-thickness direction which is perpendicular to the thickness direction. The rare-earth magnet-forming sintered body further has at least two regions respectively having defined axis orientation angles different each other by 20° or more. The defined axis orientation angle is herein defined as a most frequently appearing orientation angle with respect to a predefined reference line, among orientation angles of a plurality of magnet material particles contained in a rectangular area in any position in a plane containing a thickness direction and a cross-thickness direction. Further, in the magnet material particles contained in the rectangular area, a deviation of the orientation angle of each easy magnetization axis of each magnet material particle with respect to the axis orientation angle defined for the particular rectangular area is not larger than 16°. In one aspect of the present invention, the aforementioned region is defined as a rectangular region containing equal to or more than 30, for example equal to or more than 200, or equal to or more than 300 of the magnet material particles. In another aspect, the area is defined as a rectangular region of a square shape having each side length of 35 μm.

According to the above aspects of the invention, it is preferred that the magnet material particles have an average diameter equal to or less than 5 μm, more preferably equal to or less than 3 μm, and most preferably equal to or less than 2 μm. Further, the magnet material particle after sintering preferably has an aspect ratio equal to or less than 2.2, more preferably equal to or less than 2, and most preferably equal to or less than 1.8. In another aspect, the present invention provides a rare-earth sintered magnet which is obtained by magnetizing the rare-earth magnet-forming sintered body. According to a preferable aspect of the present invention, the three dimensional shape is of a configuration having a cross section perpendicular to the lengthwise direction of a trapezoidal shape. According to a further preferable aspect of the present invention, the three dimensional shape is of a configuration having a cross section perpendicular to the lengthwise direction of an arcuate shape wherein the first and second surfaces are of annular shape having a common center of arc.

### Effect of Invention

The rare-earth magnet-forming sintered body includes a number of magnet material particles which are sintered together, so that the density of the magnet material particles is substantially higher than that in a bond magnet such as the one described in the patent document 8. Therefore, a rare-earth sintered magnet obtained by magnetizing the sintered body of the present invention can present a magnet performance which is significantly superior to that obtained by a bond magnet. Further, in the sintered body of the present invention has a highly accurate orientations of easy magnetization axes of magnet material particles, as represented by an orientation angle deviation equal to or less than 16° for each of easy magnetization axes of a plurality of magnet material particles contained in a rectangular area which contains equal to or more than 30, such as 200 or 300 of magnet material particles, or in a square area having each side dimension of 35 μm, so that the rear-earth magnet obtained by magnetizing the sintered body shows a magnet performance which is superior to that of a conventional rare-earth sintered magnet.

### BRIEF DESCRIPTION OF DRAWINGS

FIG. 1 is a diagrammatic end view showing orientation angles and an axis orientation angle, wherein (a) shows an example of orientations of easy magnetization angles of magnet material particles in a rare-earth magnet, and (b) is an enlarged illustration of magnet material particles, particularly showing “orientation angles” of easy magnetization axes and a manner of determining “axis orientation angle”:

FIG. 2 is a graph showing a manner of determining an orientation angle deviation:

FIG. 3 shows a distribution of orientation angles based on an EBSD analysis, wherein (a) is a perspective view of coordinate axes taken in a rare-earth magnet, (b) shows examples of polar point diagrams at a central portion and the opposite end portions as obtained by the EBSD analysis: and (c) shows axis orientation angles in a section of the magnet taken along the A2 axis:

FIG. 4 shows an example of a rare-earth magnet-forming sintered body in accordance with one embodiment of the present invention, wherein (a) is a sectional view showing an overall configuration, and (b) is an enlarged view of an end portion:

FIG. 5 is a fragmentary sectional view of a rotor of an electric motor showing an example of a slot for insertion of a rare-earth magnet in accordance with one embodiment of the present invention:

FIG. 6 is an end view of a rotor shown in FIG. 5 having a permanent magnet inserted thereto:

FIG. 7 is a cross-sectional view of an electric motor to which a permanent magnet of the present invention can be applied:

FIG. 8 is a diagram showing a distribution of magnetic flux density in the embodiment shown in FIG. 4:

FIG. 9 is a diagrammatic illustration of production processes for producing the sintered body for forming a rare-earth permanent magnet in accordance with the embodiment shown in FIG. 1 wherein (a) to (d) depict process steps up to formation of a green sheet:

FIG. 10 shows in sectional views of a work sheet piece depicting orienting process steps for orienting the easy magnetization axes of the magnet material particles in accordance with one embodiment of the present invention, wherein (a) shows a sectional view of the work sheet piece during a magnetic field application, (b) is a sectional view of the work sheet piece which has been subjected to a deformation process after the application of the magnetic field, and (c) shows a bending process for forming the first shaped body into a second shaped body:

FIG. 11 is a graph showing a preferable temperature increase in calcination process:

FIG. 12 shows sectional views similar to FIGS. 10 (a) and (b) of another embodiment, wherein (a) shows a first shaped body, and (b) shows a second shaped body:

FIG. 13 are diagrammatical illustrations similar to FIGS. 12(a) and (b) of different embodiments, wherein (a) shows a first shaped body in accordance with one aspect, (b) shows a second shaped body of the one aspect, (c) shows a second shaped body in accordance with another aspect, (d) shows a first shaped body in accordance with a further aspect, (e) shows a second shaped body of the further aspect, and (f) shows a second shaped body in accordance with still further aspect:

FIG. 14 shows an embodiment of the present invention for producing an annular magnet having a radial orientation, wherein (a) is a side view showing a first shaped body, (b) is a perspective view showing a second shaped body, and (c) is a perspective view showing a second shaped body which has been formed into an annular shape in a way different from that shown in (b) for producing an annular magnet having an axial orientation:

FIG. 15 shows an example wherein a magnet having a Halbach arrangement is produced using the annular magnets made in accordance with the embodiments shown in FIG. 14:

FIG. 16 is a diagrammatical perspective view of a die cavity adapted to be used for producing the first shaped body in accordance with the embodiments 5 to 9:

FIG. 17 shows a deformation process for shaping the second shaped body from the first shaped body in the embodiments 5 to 9:

FIG. 18 is a diagrammatical illustration showing points of orientation axes analysis in the rare-earth magnet-forming sintered body of the embodiments 5 to 9: and,

FIG. 19 shows coordinates and reference plane for measurements of orientation axis angles.

### DESCRIPTION OF EMBODIMENTS

The present invention will now be described with reference to embodiments shown in the drawings. Before the description is made on embodiments, description will be made with respect to the definitions of terms and measurements of orientation angles.

### [Orientation Angle]

The term “orientation angle” herein means an angle of the direction of an easy magnetization axis of a magnet material particle with respect to a predefined reference line.

### [Axis Orientation Angle]

The term “axis orientation angle” herein means a most frequently appearing orientation angle among orientation angles of a plurality of magnet material particles contained in a predefined discrete area in any specific position in a plane of magnet. In the present invention, the discrete area for determining the axis orientation angle is a rectangular area containing the magnet material particles in number of at least 30, or a square having a length of 35 μm in each side.

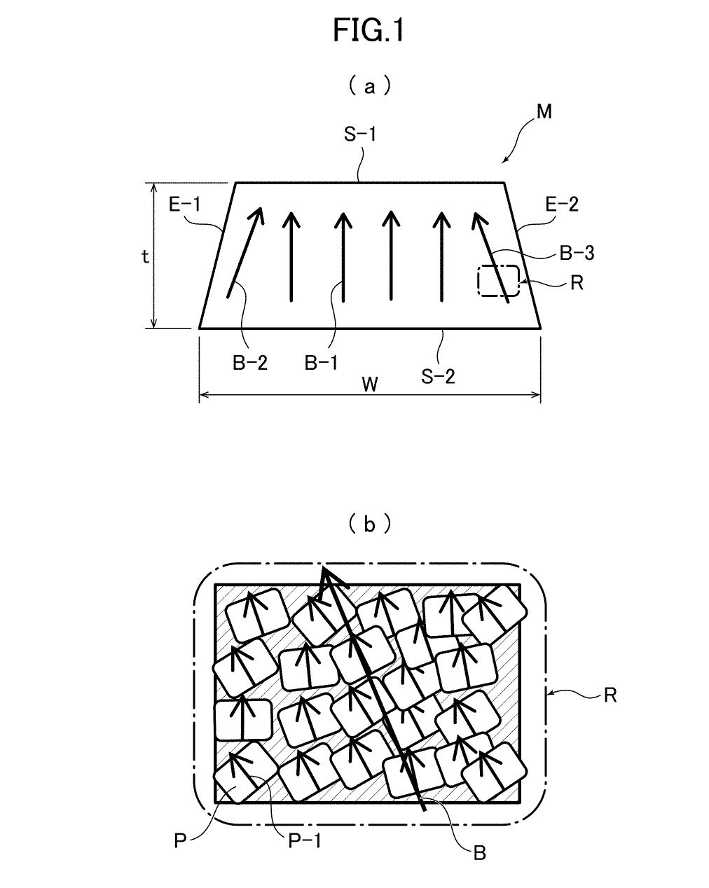

Referring now to FIG. 1, there are shown an orientation angle and an axis orientation angle. FIG. 1(a) is a cross-sectional view showing an example of orientation of easy magnetization axes of magnet material particles, wherein the rare-earth magnet M has a first surface S-1, a second surface S-2 apart from the first surface by a distance corresponding to a thickness t, and a width w, end surfaces E-a and E-2 being formed in widthwise opposite end portions. In the illustrated embodiment, the first surface S-1 and the second surface S-2 are planar surfaces which are parallel with each other. In the illustrated sectional view, the first surface S-1 and the second surface S-2 are designate by two mutually parallel straight lines. The end surface E-1 is slanted in up and right direction with respect to the first surface S-1, and the end surface E-2 is similarly slanted up and left direction with respect to the second surface S-2. An arrow B-1 is shown as indicating an orientation axis or direction of an easy magnetization axis of a magnet material particle in a widthwise central region of the rare-earth magnet M. To the contrary, an arrow B-2 shows an orientation axis or direction of an easy magnetization axis of a magnet material particle in a region adjacent to the end surface E-1. Similarly, an arrow B-3 shows an orientation axis or direction of an easy magnetization axis of a magnet material particle in a region adjacent to the end surface E-2.

The “axis orientation angle” is an angle between the orientation axis indicated by the arrow B-1, B-2 or B-3 and a reference line. The reference line can be arbitrary defined, but in a case where the section of the first surface S-1 is designated by a straight line such as an example shown in FIG. 1(a), it is convenient to adopt the first surface as the reference line. FIG. 1(b) is a grammatical enlarged illustration showing an “orientation angle” of the easy magnetization axis of each magnet material particle and the manner of determining an “axis orientation angle”. An arbitrary portion, for example a rectangular area R shown in FIG. 1(a) is shown in FIG. 1 (b) in an enlarged scale. The rectangular area R contains a number of magnet material particles P such as not less than 30, for example, 200 or 300 pieces of magnet material particles P. If the number of magnet material particles contained in the rectangular area is large, the accuracy of measurement is enhanced, however, even with the number of 30, it is possible to conduct a measurement with a sufficient accuracy. Each of the magnet material particles P has an easy magnetization axis P-1. The easy magnetization axis does not usually have any directionality, but when the particle is magnetized, a vector having a directionality is produced. In FIG. 1(b), the easy magnetization axis is shown as having a directionality considering a polarity in which the particle is to be magnetized.

As shown in FIG. 1(b), the easy magnetization axis P-1 of each magnet material particle P has an “orientation angle” which is an angle between the direction of the easy magnetization axis and a reference line. The “axis orientation angle” B is then defined as a most frequently appearing angle among the “orientation angles” of the easy magnetization axes P-1 of the magnet material particles P in the rectangular area R shown in FIG. 1(b).

### [Deviation Angle of Orientation Angle]

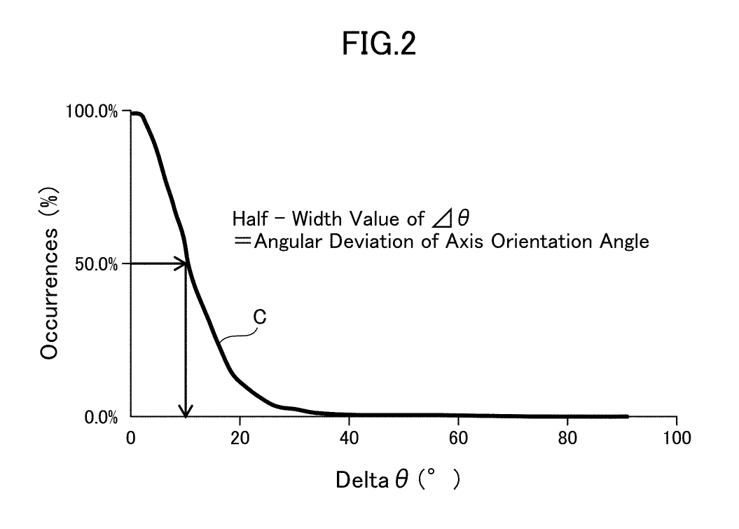

In any rectangular area, the axis orientation angle is determined and, for all of the magnet material particles existing in the particular rectangular area, differences between the orientation angles and the axis orientation angle are determined. Then, distributions of the differences are drawn in a graph in terms of number of occurrences and the angle values of the differences. A half-value width is then determined in the graph as the orientation deviation angle. In FIG. 2, there is shown a graph for use in determining an orientation deviation angle. Referring to FIG. 2, there is shown by a curve C a distribution of the difference Δθ between each of the easy magnetization axes of the magnet material particles and the axis orientation angle. In a vertical axis, the position of the maximum number of occurrence is shown as 100%, and a value of the difference Δθ corresponding to a 50% of number of occurrence is taken as the half-value width.

### [Measurement of Orientation Angle]

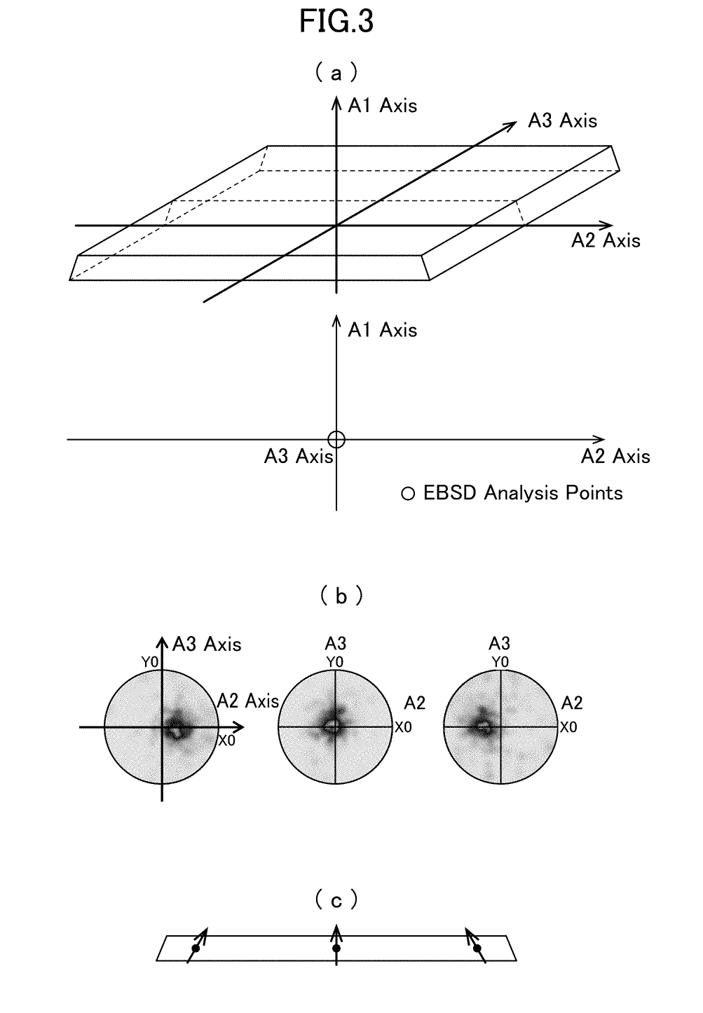

The orientation angle of the easy magnetization axis in each individual magnet material particle P can be determined by an “Electron Back Scattering Diffraction Analysis” (EBSD Analysis) based on images taken by a scanning electron microscope (SEM). Examples of devices which can be used for the analysis are Model JSM-70001F manufactured by Nihon Electron KK having head office in Akishima City, Tokyo, Japan which is incorporated with an EBSD Detector (AZtecHKL EBSD NordlysNano Integrated) manufactured by Oxford Instruments, and a scanning electron microscope Model SUPRA40VP manufactured by ZEISS which is incorporated with an EBSD detector (Hikari High Speed EBSD Detector) manufactured by EDAX Co. Further, as entities for taking charge of such analysis for an outside entity, there are JFE Techno-Research K.K. in Nihonbashi, Chuou City, Tokyo, Japan, and K.K. Nitto Analysis Center in Ibaraki City, Osaka, Japan. By adopting an EBSD analysis, it is possible to determine the oriented angle of the easy magnetization axis in each magnet material particle existing in any specified area. FIG. 3 shows an example of designating an orientation of an easy magnetization axis in accordance with EBSD analysis, wherein FIG. 3(a) illustrates reference axes taken in a rare-earth magnet, and FIG. 3(b) shows examples of polar point diagrams at a central portion and the opposite end portions as obtained by the EBSD analysis. Further, FIG. 3(c) shows axis orientation angles in a section of the magnet taken along the A2 axis. The axis orientation angle can be designated by dividing an orientation vector of an easy magnetization axis into a component in a plane containing the A1 and A2 axes, and another component in a plane containing A1 and A3 axes. The A2 axis extends in the widthwise direction, while the A3 axis extends in the thickness direction. The Figure shown in the center of FIG. 3(b) indicates that the easy magnetization axis is oriented in the widthwise central portion in a direction substantially along the A1 axis. Similarly, the figure in the right portion of FIG. 3(b) indicates that the orientation of the easy magnetization axis is slanted in the right hand end portion from bottom toward left, upper direction along the plane containing the A1 and A2 axes. Such orientations are shown as orientation vectors in FIG. 3(c).

### [Crystal Orientation]

It is possible to provide an illustration showing an inclination angle of the easy magnetization axis of each magnet material particle existing in any specified discrete area with respect to an axis perpendicular to a viewing plane, based on an image taken by a scanning electron microscope (SEM image).

### PREFERRED EMBODIMENTS

Embodiments of the present invention will now be described with reference to the drawings.

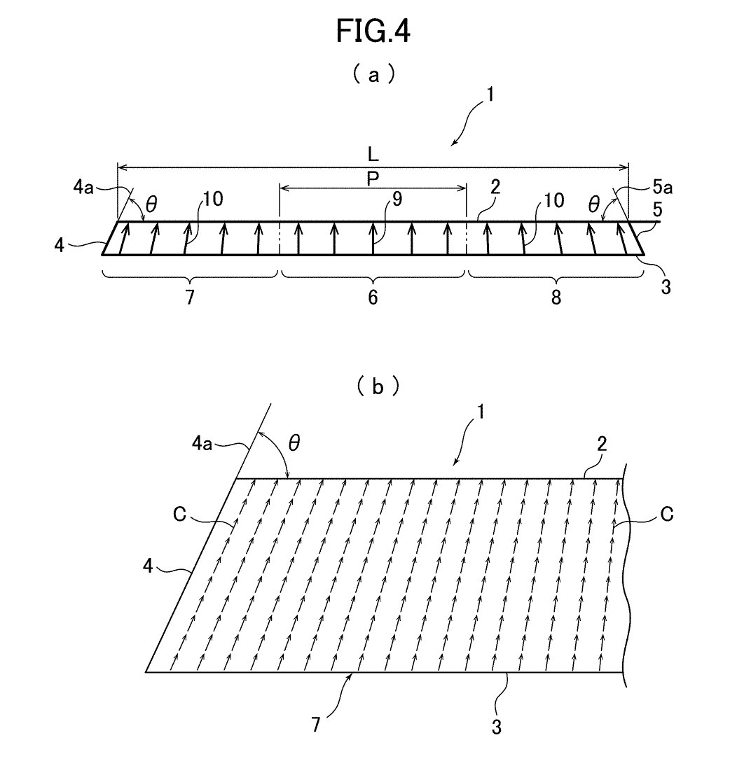

Referring to FIGS. 4 to 7, there are shown a rare-earth magnet-forming sintered body in accordance with an embodiment of the present invention, and an example of an electric motor incorporated with permanent magnets which are produced from the sintered body. The rare-earth magnet-forming sintered body 1 contains an Nd—Fe—B type magnet material as a magnet material. The Nd—Fe—B type magnet material may herein contain, for example, in weight percent, 27.0 to 40.0 wt. % of R (R represents one or more rare-earth elements including Y), 0.6 to 2 wt. % of B, and 60 to 75 wt. % of Fe. Typically, an Nd—Fe—B type magnet material contains 27 to 40 wt. % of Nd, 0.8 to 2 wt. % of B. and 60 to 75 wt. % of Fe which is an electrolytic iron. For the purpose of enhancing a magnetic property, such magnet material may contain small amounts of other elements such as Dy, Tb, Co, Cu, Al, Si, Ga, Nb, V, Pr, Mo, Zr, Ta, Ti, W, Ag, Bi, Zn, Mg, etc.

Referring to FIG. 4, it is to be noted that the magnet-forming sintered body 1 in accordance with this embodiment is formed from fine particles of the aforementioned magnet material by integrally sintering and shaping the particles of the magnet material. The sintered body 1 has an upper side 2 and a lower side 3 which are parallel with each other, and end surfaces 4 and 5 at the opposite end portions, the end surfaces being slanted with respect to the upper side 2 and the lower side 3. The upper side 2 is a side of a section corresponding to the second surface and the lower side 3 is a side of a section corresponding to the first surface. The slanted angles of the end surfaces 4 and 5 are defined as angles θ respectively between the upper side 2 and extension lines 4a and 5a of the end surfaces 4 and 5. In a preferable aspect, the slanted angle θ is in the range between 45° to 80°, more preferably between 55° to 80°. As the result, the magnet-forming sintered body 1 has a configuration having a trapezoidal shape with the upper side 2 being shorter than the lower side 3 in a widthwise section.

The magnet-forming sintered body 1 has a plurality of regions divided along the widthwise direction and including a central region 6 of a predefined dimension, and end regions 7 and 8 at the opposite end portions. In the central region 6, the magnet material particles contained in the region 6 have easy magnetization axes oriented substantially perpendicular to the upper side 2 and the lower side 3 to provide a parallel orientation pattern. To the contrary, in the end regions 7 and 8, the magnet material particles contained in the regions 7 and 8 have easy magnetization axes slanted with respect to the thickness direction toward the central region 6 from bottom to upper direction. Specifically, the slanted directions at positions adjacent to the end surfaces 4 and 5 are along the slanted angles θ of the respective end surface 4 and 5, but in positions adjacent to the central region 6, the easy magnetization axes are directed substantially perpendicularly to the upper side 2, and the slanted angles gradually increase in positions closer to the central region 6 than in positions adjacent to the end surfaces 4 and 5. Such orientations of the easy magnetization axes are illustrated in FIG. 4(a) wherein the parallel orientation in the central region 6 is shown by arrows 9, and the orientations in the end regions 7 and 8 are shown by arrows 10. Describing the orientations in the end regions 7 and 8 in other terms, the easy magnetization axes of the magnet material particles contained in these regions 7 and 8 are oriented such that their directions are concentrated in predetermined ranges corresponding to the widthwise dimensions of the end regions 7 and 8 along the upper side 2 between corners where the upper side 2 intersects the respective end surfaces 4 and 5 and the border of the central region 6 and the respective end regions 7 and 8. As the results of such orientations, in the end regions 7 and 8, the density of the magnet material particles having easy magnetization axes oriented toward the upper side 2 becomes higher than that in the central region 6. According to a preferable aspect of the invention, the widthwise dimensions of the central region 6 and the end regions 7 and 8 are determined such that a parallel ratio P/L which is defined as a ratio of a parallel orientation length P to the widthwise dimension L of the upper side 2 is in a range of 0.05 to 0.8, more preferably in a range of 0.2 to 0.5. In the embodiment under discussion, the orientations of the easy magnetization axes in the central region 6 are different by an angle equal to or more than 20° from the orientations of the easy magnetization axes of the magnet material particles at positions close to the end surfaces 4 and 5. Herein, such orientation is referred as a “non-parallel orientation”.

Among the aforementioned orientations of the easy magnetization axes of the magnet material particles in the end regions 7 and 8, those in the end region 7 are shown in an exaggerated manner in FIG. 4(b). Referring to FIG. 4 (b), the easy magnetization axis C of each magnet material particle is oriented with a slanted angle θ in a position adjacent to the end surface 4 substantially along the end surface 4. The slanted angle of the easy magnetization axis is then gradually increases in positions from the end portion toward the position closer to the central region 6. Specifically, the orientation of the easy magnetization axis C is patterned such that directions of the axes C are concentrated from the lower side 3 toward the upper side 2, so that the density of the magnet materials having the easy magnetization axes oriented toward the upper side 2 is larger than in a parallel orientation.

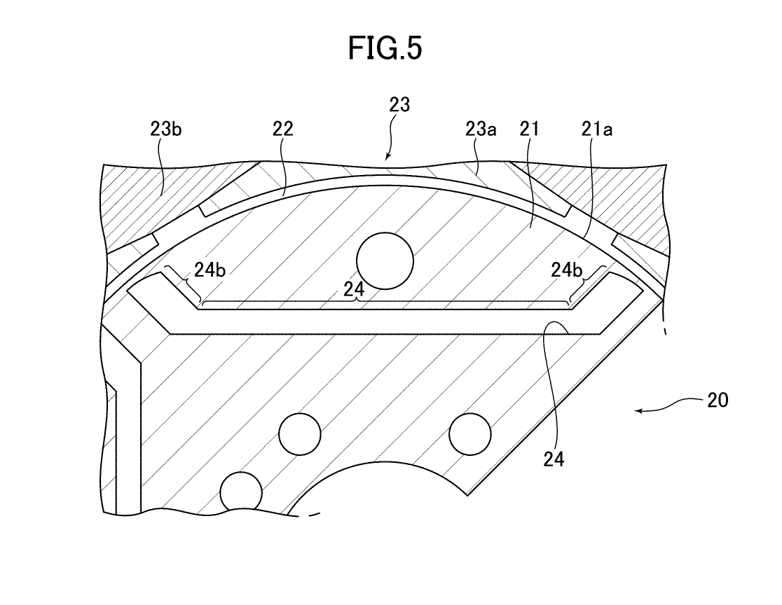

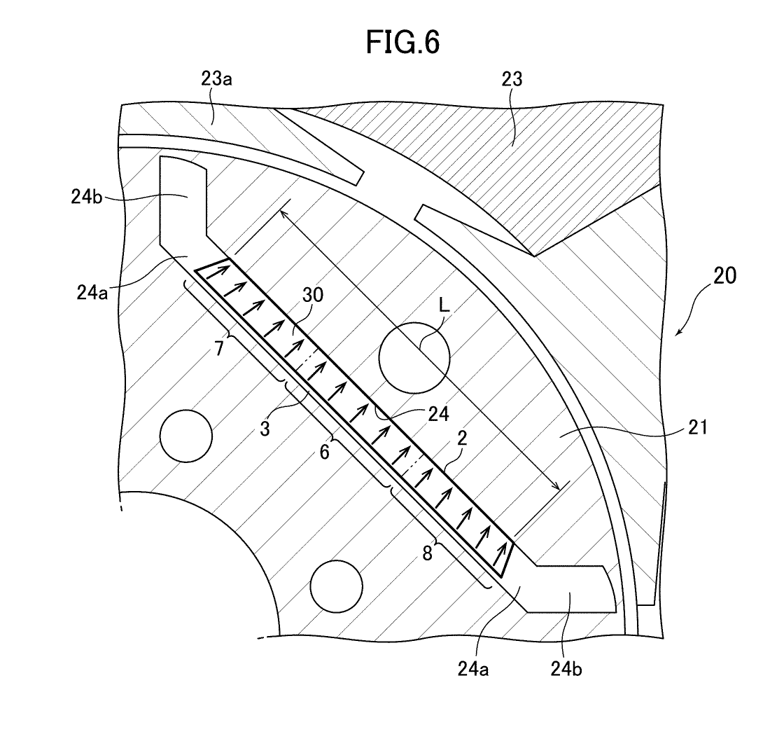

FIG. 5 is a sectional view in an enlarged scale of a rotor core portion in an electric motor 20 which is suitable for use rare-earth magnets produced by magnetizing the magnet-forming sintered body 1 having the aforementioned orientations of the easy magnetization axes. There is shown a rotor core 21 having a circumferential surface 21a and arranged in a stator 23 for rotation with the circumferential surface 21a opposed to the stator 23 with an air gap 22 formed between the surface 21a and the stator 23. The stator 23 is provided at circumferentially spaced positions with a plurality of teeth 23a each having a field coil wound thereon. The aforementioned air gap 22 is therefore formed between end surfaces of the teeth 23a and the circumferential surface 21a. The rotor core 21 is formed with magnet receiving slots 24, only one of the slots 24 being shown. The slot 24 has a straight central portion 24a, and a pair of oblique portions 24b which extend from the opposite end portions of the central portion 24a obliquely toward the circumferential surface 21a of the rotor core 21. As shown in FIG. 6, each of the oblique portions 24b has a terminal end portion located close to the circumferential surface 21a of the rotor core 21.

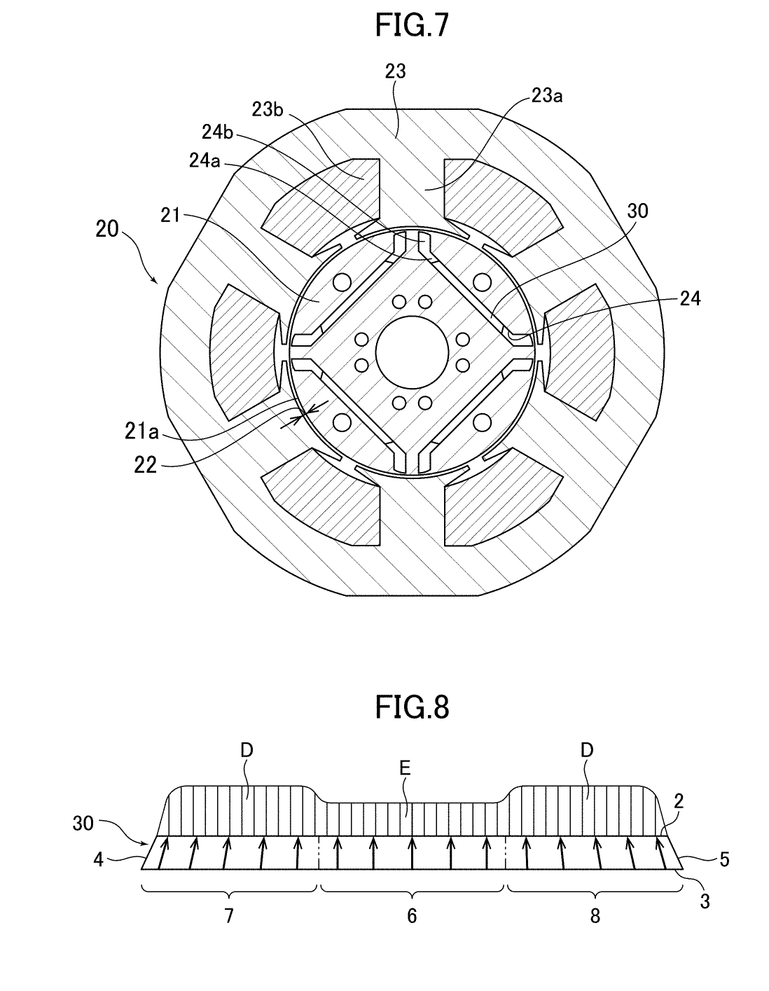

FIG. 6 shows a rare-earth magnet 30 obtained by magnetizing the magnet-forming sintered body 1 inserted into the magnet receiving slot 24 in the rotor core 21 shown in FIG. 5. As shown in FIG. 6, the rare-earth magnet 30 is inserted into the straight central portion 24a of the magnet receiving slot 24 formed in the rotor core 21 with the upper side 2 directed outwardly, namely, with the upper side 2 faced toward the stator 23. At portions outwards the opposite end portions of the inserted magnet 30, there are left gap portions which are comprised of portions of the straight central portion 24a and the oblique portions 24b. An overall view of the electric motor 20 having the permanent magnets inserted into the slots 24 of the rotor core 21 is shown in FIG. 7.

FIG. 8 shows a distribution of density of magnetic flux in the rare-earth permanent magnet 30 formed in accordance with the present embodiment. As shown in FIG. 8, the magnetic flux density D in the end regions 7 and 8 of the magnet 30 is higher than the magnetic flux density E in the central region 6. Therefore, when the magnets 30 are embedded in the rotor core 21 of the electric motor 20 and the motor 20 is operated, it is possible to have demagnetization suppressed even if a magnetic flux from the stator 23 acts on each of the end portions of the magnet 30. Therefore, there will be an adequate magnetic flux retained in the end portion of the magnet 30, so that it is possible to prevent any possible output decrease in the motor 20.

### [Production Method for Rare-Earth Permanent Magnet-Forming Sintered Body]

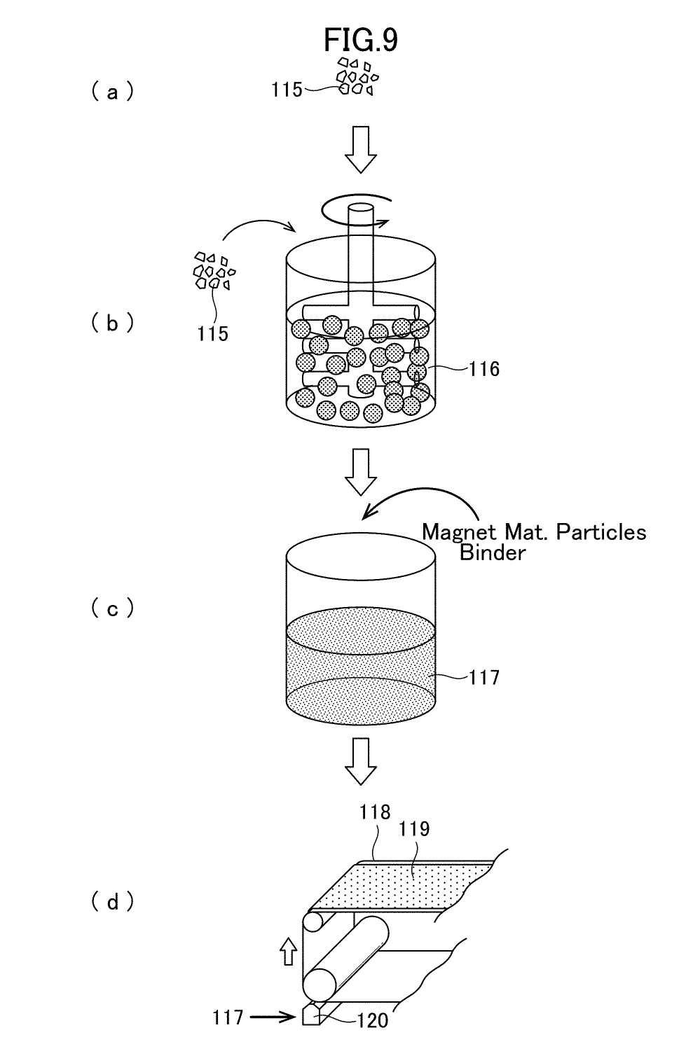

Next, with reference to FIG. 9, description will be made on a production method for the rare-earth permanent magnet-forming sintered body 1 according to one embodiment of the present invention. FIG. 9 is a schematic diagram depicting a production process of the permanent magnet-forming sintered body 1 according to the aforementioned embodiments.

First of all, an ingot of a magnet material comprised of an Nd—Fe—B based alloy having a given mixing ratio is produced by a known casting process. Typically, the Nd—Fe—B based alloy usable for a neodymium magnet has a composition comprising 30 wt % of Nd, 67 wt % of Fe which is preferably electrolytic iron, and 1.0 wt % of B. Subsequently, this ingot is coarsely pulverized to a size of about 200 μm, using heretofore-known means such as a stamp mill or a crusher. Alternatively, the ingot may be melted and subjected to a strip casting process to produce flakes, and then the flakes may be coarsely powdered by a hydrogen cracking process. In this way, coarsely-pulverized magnet material particles 115 are obtained (see FIG. 9(a)).

Subsequently, the coarsely-pulverized magnet material particles 115 are finely pulverized by a heretofore-known pulverization method such as a wet process using a bead mill 116, or a dry process using a jet mill. For example, in the fine pulverization based on a wet process using a bead mill 116, a solvent is filled in the bead mill 116 charged with beads as a pulverizing medium, and the coarsely-pulverized magnet material particles 115 is input into the solvent. Then, the coarsely-pulverized magnet material particles 115 are finely pulverized, in the solvent, to a mean particle size falling within a given range, e.g., 0.1 μm to 5.0 μm, preferably equal to or less than 3 μm to thereby disperse the resulting magnet material particles in the solvent (see FIG. 9(b)). Subsequently, the magnet material particles contained in the solvent after the wet pulverization are dried by drying mean such as vacuum drying, and the dried magnet material particles are taken out (not depicted). The type of solvent usable in the pulverization is not particularly limited. For example, it is possible to use organic solvent such as: alcohols such as isopropyl alcohol, ethanol and methanol: esters such as ethyl acetate: lower hydrocarbons such as pentane and hexane; aromatics such as benzene, toluene and xylene; and ketones; and mixtures thereof. The solvent is not limited to an organic solvent. For example, it is possible to use an inorganic solvent such as a liquefied inert gas such as liquefied argon, and other inorganic solvents. In any case, it is preferable to use a solvent containing no oxygen atom therein.

On the other hand, in the fine pulverization based on a dry process using a jet mill, the coarsely-pulverized magnet material particles 115 are finely pulverized by the jet mill, in (a) an atmosphere consisting inert gas such as nitrogen gas, Ar gas or He gas, wherein an oxygen content of the inert gas is not greater than 0.5%, preferably substantially 0%, or (b) an atmosphere consisting inert gas such as nitrogen gas, Ar gas or He gas, wherein an oxygen content of the inert gas is in the range of 0.001 to 0.5%, and pulverized into fine particles having an average particle size falling within a given range, such as less than 6.0 μm, or 0.7 μm to 5.0 μm. As used herein, the term “the concentration of oxygen is substantially 0%” does not limitedly mean that the concentration of oxygen is absolutely 0%, but means that oxygen may be contained in an amount to an extent that it very slightly forms an oxide layer on surfaces of the fine particles.

Subsequently, the magnet material particles finely pulverized by the bead mill 116 or other pulverizing means are formed into a desired shape. For shaping of the magnet material particles, a mixture obtained by mixing the finely-pulverized magnet material particles 115 and a binder together is preliminarily prepared. As the binder, it is preferable to use a resin material. In the case where a resin is used as the binder, it is preferable to use a polymer containing no oxygen atom in its structure and having a depolymerization property. Further, it is preferable to use a thermoplastic resin so as to enable a residue of the mixture of the magnet material particles and the binder, occurring when the mixture is formed into a desired shape such as a rectangular parallelepiped shape, as described later, to be reused, and enable magnetic field orientation to be performed under a condition that the binder is softened as a result of heating the mixture. More specifically, a polymer is suitably used which comprises one or more polymers or copolymers formed from a monomer represented by the following general formula (1):

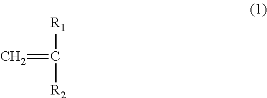

(where each of R1 and R2 denotes one of a hydrogen atom, a lower alkyl group, a phenyl group and a vinyl group.)

Examples of a polymer meeting the above conditions include: polyisobutylene (PIB) as a polymer of isobutylene; polyisoprene (isoprene rubber (IR)) as a polymer of isoprene; polybutadiene (butadiene rubber (BR)) as a polymer of 1,3-butadiene; polystyrene as a polymer of styrene: a styrene-isoprene-styrene block copolymer (SIS) as a copolymer of styrene and isoprene: butyl rubber (IIR) as a copolymer of isobutylene and isoprene: a styrene-isobutylene-styrene copolymer which is a copolymer of styrene and isobutylene: a styrene-butadiene-styrene block copolymer (SBS) as a copolymer of styrene and butadiene; a styrene-ethylene-butadiene-styrene copolymer (SEBS) as a copolymer of styrene, ethylene and butadiene; a styrene-ethylene-propylene-styrene copolymer (SEPS) as a copolymer of styrene, ethylene and propylene; an ethylene-propylene copolymer (EPM) as a copolymer of ethylene and propylene; EPDM obtained by copolymerizing diene monomers together with ethylene and propylene; polyethylene as a polymer of ethylene: polypropylene as a polymer of propylene; a 2-methyl-1-pentene polymerized resin as a polymer of 2-methyl-1-pentene; a 2-methyl-1-butene polymerized resin as a polymer of 2-methyl-1-butene; and an α-methylstyrene polymerized resin as a polymer of α-methylstyrene. A resin to be used as the binder may have a composition containing a polymer or copolymer of monomers containing an oxygen atom and/or a nitrogen atom (e.g., poly(butyl methacrylate) or poly(methyl methacrylate)) in a small amount. Further, a monomer which does not meet the general formula (1) may be partially copolymerized. Even in such a situation, it is possible to achieve the object of the present invention.

As a resin to be used as the binder, it is desirable, from a viewpoint of adequately performing magnetic field orientation, to use a thermoplastic resin capable of being softened at a temperature of 250° C. or less (i.e., having a softening temperature of 250° C. or less), more specifically a thermoplastic resin having a glass-transition temperature or flow starting temperature of 250° C. or less.

In order to disperse the magnet material particles over the thermoplastic resin, it is desirable to add a dispersant in an appropriate amount. As the dispersant, it is desirable to add at least one selected from the group consisting of alcohol, carboxylic acid, ketone, ether, ester, amine, imine, imide, amide, cyanogen, phosphorous functional group, sulfonic acid, a compound having an unsaturated bond such as a double bond or a triple bond, and a liquid, saturated hydrocarbon compound. Two or more of them may be used in the form of a mixture. Further, in advance of aftermentioned operation of applying a magnetic field to the mixture of the magnet material particles and the binder to thereby magnetically orient the magnet material particles, the mixture is heated to allow such magnetic field orientation treatment to be performed under a condition that the binder component is softened.

By using a binder satisfying the above conditions to serve as the binder to be mixed with the magnet material particles, it is possible to reduce an amount of carbon and an amount of oxygen remaining in a rare-earth permanent magnet-forming sintered body after sintering. Specifically, an amount of carbon remaining in a rare-earth permanent magnet-forming sintered body after sintering can be reduced to 2000 ppm or less, more preferably 1000 ppm or less. Further, an amount of oxygen remaining in a rare-earth permanent magnet-forming sintered body after sintering can be reduced to 5000 ppm or less, more preferably 2000 ppm or less.

An addition amount of the binder is set to a value capable of, when shaping a slurry-form or heated and melted compound, filling gaps among the magnet material particles so as to provide improved thickness accuracy to a shaped body obtained as a result of the shaping. For example, a ratio of the binder to a total amount of the magnet material particles and the binder is set in the range of 1 wt % to 40 wt %, more preferably in the range of 2 wt % to 30 wt %, still more preferably in the range of 3 wt % to 20 wt %.

In the following embodiments, the mixture is once formed into a shape other than that of an intended product, and a magnetic field is applied to the resulting shaped body to have the easy magnetization axes of the magnet material particles oriented, and in the case of the embodiment shown in FIGS. 4 to 8, the resulting shaped body is thereafter subjected to shaping and sintering to obtain a product having a desired shape such as a trapezoidal shape as depicted, for example, in FIG. 4(a). Particularly, in the following embodiments, the mixture comprising the magnet material particles and the binder, i.e., a compound 117, is once formed into a sheet-like green (unprocessed or untreated) shaped body (hereinafter referred to as “green sheet” or “shaping process sheet”), and then further formed into a shape for the orientation treatment. For forming the mixture, particularly, into a sheet shape, it is possible to adopt a forming method using, for example, a hot-melt coating process which comprises heating the compound 117 which comprises the mixture of the magnet material particles and the binder, and then coating the resulting melt onto a substrate to thereby form the melt into a sheet shape, or a slurry coating process which comprises coating a slurry containing the magnet material particles, the binder and an organic solvent, on a substrate, to thereby form the slurry into a sheet shape.

In the following description, description will be made on a production process in connection with a formation of the green sheet using, particularly, the hot-melt coating process, however, the present invention is not limited to such a specific coating process. For example, the compound 117 may be charged in a shaping die and shaped under a pressure of 0.1 to 100 MPa at a temperature between a room temperature and an elevated temperature such as 300° C. Alternatively, the compound 117 heated to a softening temperature may be charged into a molding die under an injection pressure to form a desired shape.

As already described, a binder is mixed with the magnet material particles finely pulverized using the bead mill 116 or other pulverizing means, to prepare a clayey mixture comprising the magnet material particles and the binder, i.e., a compound 117. In this process, it is possible to use, as the binder, a mixture of a resin and a dispersant as mentioned above. As one example of the binder, it is preferable to use a thermoplastic resin comprising a polymer containing no oxygen atom in its structure and having a depolymerization property. Further, as the dispersant, it is preferable to add at least one selected from the group consisting of alcohol, carboxylic acid, ketone, ether, ester, amine, imine, imide, amide, cyanogen, phosphorous functional group, sulfonic acid, and a compound having an unsaturated bond such as a double bond or a triple bond. As to an addition amount of the binder, in the compound 117 after addition of the binder, a ratio of the binder to a total amount of the magnet material particles and the binder is set in the range of 1 wt % to 40 wt %, more preferably in the range of 2 wt % to 30 wt %, still more preferably in the range of 3 wt % to 20 wt %, as mentioned above.

Further, an addition amount of the dispersant is preferably determined depending on a particle size of the magnet material particles, wherein it is recommended to increase the addition amount as the particle size of the magnet material particles becomes smaller. Specifically, the addition amount may be set in the range of 0.1 parts to 10 parts, preferably in the range of 0.3 parts to 8 parts, with respect to 100 parts of the magnet material particles. If the addition amount is excessively small, a dispersion effect becomes poor, possibly leading to deterioration in orientation property. On the other hand, if the addition amount is excessively large, the dispersant is likely to contaminate the magnet material particles. The dispersant added to the magnet material particles adheres onto surfaces of the magnet material particles, and acts to facilitate dispersion of the magnet material particles to provide the clayey mixture, and to assist turning of the magnet material particles in the aftermentioned magnetic field orientation treatment. As a result, it becomes possible to facilitate orientation during application of a magnetic field so as to uniform respective directions of easy magnetization axes of the magnet material particles, into approximately the same direction, i.e., so as to increase the degree of orientation. Particularly, in the case where the binder is mixed with the magnet material particles, the binder is present around the surfaces of the magnet material particles, so that a frictional force against the magnet material particles during the magnetic field orientation treatment is increased, thereby possibly leading to deterioration in orientation property of the magnet material particles. Thus, the effect arising from addition of the dispersant becomes more important.

Preferably, the mixing of the magnet material particles and the binder is performed in an atmosphere consisting of inert gas such as nitrogen gas, Ar gas or He gas. As one example, the mixing of the magnet material particles and the binder is performed by inputting the magnet material particles and the binder into a stirring machine and stirring them using the stirring machine. In this case, with a view to enhancing kneading performance, heating-stirring (stirring under heating) may be performed. It is also desirable to perform the mixing of the magnet material particles and the binder, in an atmosphere consisting of inert gas such as nitrogen gas, Ar gas or He gas. Particularly, in the case where the coarsely-pulverized magnet material particles are finely pulverized by a wet process, the compound 117 may be obtained by adding the binder to a solvent used for pulverization, without extracting the magnet material particles from the solvent, and, after kneading the resulting mixture, volatilizing the solvent.

Subsequently, the compound 117 is formed into a sheet shape to prepare the aforementioned green sheet. Specifically, in case of employing the hot-melt coating process, the compound 117 is heated and melted to have flowability, and then coated on a support substrate 118. Subsequently, the compound 117 is solidified according to heat dissipation to form a long strip-shaped green sheet 119 on the support substrate 118. In this case, although a temperature during heating and melting of the compound 117 varies depending on a type and an amount of a binder used, it is typically set in the range of 50 to 300° C. In this case, it is to be understood that the temperature needs to be set to a value greater than the flow starting temperature of the binder used. On the other hand, in case of employing the slurry coating process, a slurry obtained by dispersing the magnet material particles, the binder and optionally an additive for facilitating the orientation, over a large volume of solvent is coated on the support substrate 118. Subsequently, the slurry is subjected to drying to volatilize the solvent therefrom to thereby form a long strip-shaped green sheet 119 on the support substrate 118.

As a coating system for the melted compound 117, it is preferable to use a system having excellent layer thickness controllability, such as a slot-die system or a calender roll system. Particularly, in order to realize high thickness accuracy, it is desirable to use a die system or a comma coating system which is a system having particularly excellent layer thickness controllability, i.e., a system capable of coating a layer having a highly-accurate thickness, on a surface of a substrate. For example, in the slot-die system, the compound 117 after being heated to have flowability is pressure-fed from a gear pump into a die, and discharged from the die to perform coating. On the other hand, in the calender roll system, the compound 117 is fed into a nip gap between two heated rolls, in a controlled amount, and the rolls are rotated to coat the compound 117 melted by heat of the rolls, onto the support substrate 118. As one example of the support substrate 118, it is preferable to use a silicone-treated polyester film. Further, it is preferable to use a defoaming agent or perform a vacuum heating defoaming process to sufficiently defoam a layer of the coated and developed compound 117 so as to prevent gas bubbles from remaining in the layer. Alternatively, the melted compound 117 may be extruded onto the support substrate 118 while being formed into a sheet shape, by an extrusion forming or injection forming, instead of being coated on the support substrate 118, to thereby form the green sheet 119 on the support substrate 118.

In the example depicted in FIG. 9, coating of the compound 117 is performed using a slot-die 120. In a step of forming the green sheet 119 using this slot-die system, it is desirable to actually measure a sheet thickness of the coated green sheet 119, and adjust a nip gap between the slot-die 120 and the support substrate 118, by feedback control based on the actually-measured value. In this case, it is desirable to reduce a variation in an amount of the flowable compound 117 to be fed to the slot-die 120, as small as possible, e.g., to ±0.1% or less, and further reduce a variation in coating speed as small as possible, e.g., to ±0.1% or less. This control makes it possible to improve the thickness accuracy of the green sheet 119. As one example, with respect to a design value of 1 mm, the thickness accuracy of the green sheet 119 may be within +10%, preferably within ±3%, more preferably within +1%. In the calender roll system, a film thickness of the compound 117 to be transferred to the support substrate 118 can be controlled by feedback-controlling calendering conditions based on an actually-measured value in the same manner as that described above.

Preferably, the thickness of the green sheet 119 is set in the range of 0.05 mm to 20 mm. If the thickness is reduced to less than 0.05 mm, it becomes necessary to laminate a plurality of layers so as to achieve a required magnet thickness, resulting in deteriorated productivity.

Subsequently, the green sheet 119 formed on the support substrate 118 by the hot-melt coating process is cut into a processing sheet piece 123 having a size corresponding to a desired magnet size. The processing sheet piece 123 corresponds to the first shaped body which has a configuration different from that of a desired magnet. Specifically, the processing sheet piece 123 corresponding to the first shaped body is subjected to a parallel magnetic field such that the easy magnetization axes of the magnet material particles contained in the processing sheet piece 123 are oriented in parallel direction, and thereafter, the processing sheet piece is deformed into a desired magnet shape. The processing sheet piece 123 is therefore shaped into a configuration wherein a non-parallel orientation is produced in a magnet of desired shape, when it is deformed into the desired magnet shape.

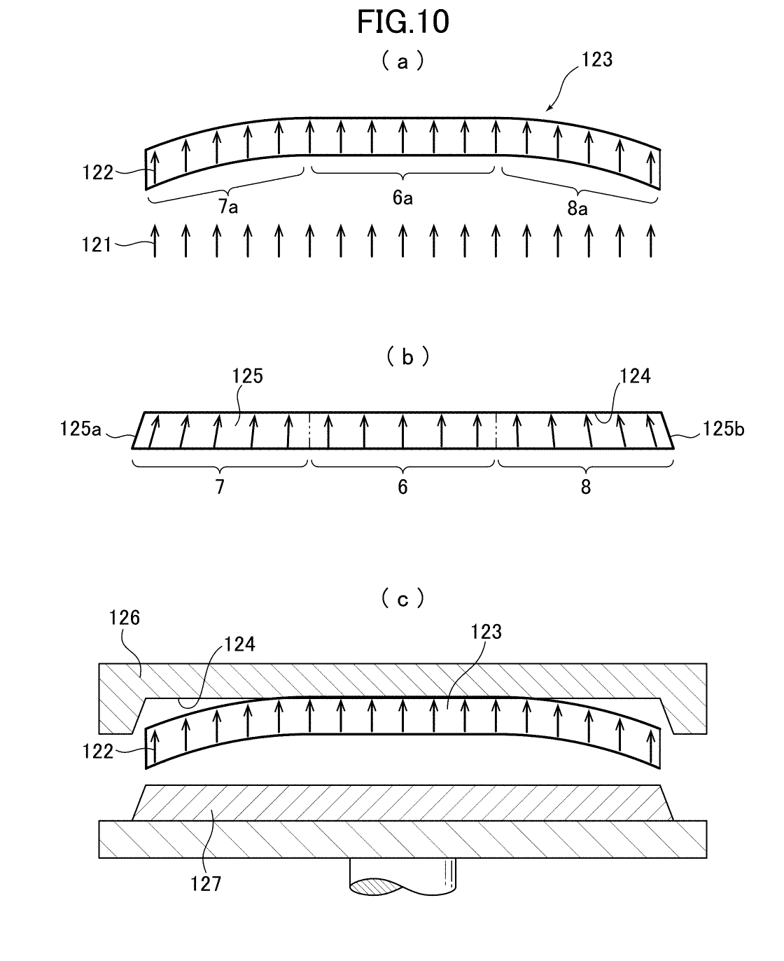

In the embodiment shown in FIGS. 4 to 8, the processing sheet piece 123 corresponding to the first shaped body is of a cross-sectional configuration including, as shown in FIG. 10(a), a straight region 6a having a widthwise dimension corresponding to that of the central region 6 in the rare-earth permanent magnet-forming sintered body 1 which is a final product having a trapezoidal shape, and arcuate regions 7a and 8a contiguous with the opposite ends of the straight region 6a. The processing sheet piece 123 has a lengthwise dimension perpendicular to the plane of the drawing, and all of the dimensions in the processing sheet piece 123 are determined, taking shrinkage during sintering process into consideration, such that desired magnet dimensions can be obtained after the sintering.

A parallel magnetic field 121 is applied to the processing sheet piece 123 depicted in FIG. 10(a), in a direction orthogonal to surfaces of the straight region 9a. Through this magnetic field application, easy magnetization axes of the magnet material particles contained in the processing sheet piece 123 are oriented in the direction of the magnetic field, in other words, in the direction parallel with the thickness direction, as depicted by the arrowed lines 122 in FIG. 10(a).

In carrying out this process, the processing sheet piece 123 is placed in a magnetic field application die (not depicted) having a cavity having a shape corresponding to that of the processing sheet piece 123, and heated to soften the binder contained in the workpiece 123. This enables the magnet material particles to be turned within the binder, i.e., enables the easy magnetization axes of the magnet material particles to be oriented with high accuracy in directions along the parallel magnetic field 121.

In this process, although a temperature and a time for heating the workpiece 123 may vary depending on a type and an amount of the binder used, they may be in ranges, respectively, to 40 to 250° C. and 1 to 60 minutes, for example. In either case, for softening the binder contained in the processing sheet piece 123, the heating temperature needs to be of a value equal to or greater than a glass-transition temperature or flow starting temperature of the binder used. Examples of means to heat the processing sheet piece 123 include a heating system using a hot plate, and a system using, as a heat source, a heating medium such as silicone oil. The magnetic field intensity during the magnetic field application may be set in the range of 5000 [Oe] to 150000 [Oe], preferably in the range of 10000 [Oe] to 120000 [Oe]. As a result, the easy magnetization axes of the magnet material particles included in the processing sheet piece 123 are oriented in parallel alignment in directions along the parallel magnetic field 121, as depicted by a reference numeral “122” in FIG. 10(a). This magnetic field application step may be configured such that a magnetic field is simultaneously applied to a plurality of the processing sheet pieces 123. In this case, the parallel magnetic field 121 may be simultaneously applied, using a die having a plurality of cavities or a plurality of dies arranged side-by-side. The step of applying a magnetic field to the processing sheet piece 123 may be performed in concurrence with the heating step, or during a period after completion of the heating step and before solidification of the binder of the processing sheet piece 123.

Subsequently, the processing sheet piece 123 in which the easy magnetization axes of the magnet material particles thereof are oriented in parallel alignment as indicated by the arrowed line 122 through the magnetic field application step depicted in FIG. 10(a) is taken out of the magnetic field application die, and transferred into a final shaping die having a trapezoidal-shaped cavity 124 having an elongate length dimension as shown in FIGS. 10(b)(c) corresponding to the straight central region 9, and a pressing male die 127 having a projection corresponding in shape to the cavity 124 is used to press the processing sheet piece 123 in the cavity 124 to have the arcuate regions 7a and 8a at the opposite ends of the processing sheet piece 123 deformed to align linearly with the central straight region 9a to thereby form a sinter processing sheet piece 125 which corresponds to the second shaped body.

With this shaping process, the processing sheet piece 123 is converted into an elongated trapezoidal configuration, wherein the arcuate regions 7a and 8a at the opposite ends are linearly aligned with the central straight region 6a, and slanted surfaces 125a and 125b are formed at the opposite ends. In the sinter processing sheet piece 125 formed in the shaping process, the easy magnetization axes of the magnet material particles contained in the central straight region 6a are maintained in a parallel orientation state, however, in the end regions 7a and 8a the easy magnetization axes are directed in a concentrated manner toward portions of the upper side corresponding to the regions, as the result of the upwardly convex arcuate shape being deformed into a straight shape contiguous with the central straight region 6a.

The oriented sintering sheet piece 125 in which the easy magnetization axes of the magnet material particles thereof are oriented in the above manner is subjected to calcining process. In the calcining process, a calcining treatment is carried out in a non-oxidizing atmosphere adjusted at an atmospheric pressure, or a pressure greater or less than atmospheric pressure such as 1.0 Pa or 1.0 MPa, under a decomposition temperature of the binder for a holding time of several hours to several ten hours. In this treatment, it is recommended to use a hydrogen atmosphere or a mixed gas atmosphere of hydrogen and inert gas. In the case where the calcining treatment is performed in a hydrogen atmosphere, a supply amount of hydrogen during the calcining treatment is controlled, for example, to 5 L/min. The calcining treatment makes it possible to remove organic compounds contained in the binder by decomposing the organic compounds to monomers by a depolymerization reaction or other reactions, and releasing the monomers. That is, decarbonizing which is treatment for reducing an amount of carbon remaining in the sinter processing sheet piece 125 is performed. Further, it is preferable to perform the calcining treatment under conditions which enable the amount of carbon remaining in the sintering sheet piece 125 to become 2000 ppm or less, preferably 1000 ppm or less. This makes it possible to densely sinter the entire sintering sheet piece 125 through subsequent sintering treatment to thereby suppress lowering of residual magnetic flux density and coercive force. In the case where a pressurization condition during the calcining treatment is set to a pressure greater than atmospheric temperature, it is desirable to set the pressure to 15 MPa or less. Further, the pressurization condition may be set to a pressure greater than atmospheric temperature, more specifically, to 0.2 MPa or more. In this case, an effect of reducing an amount of residual carbon can be particularly expected.

The binder decomposition temperature may be set based on a result of analysis of binder decomposition products and decomposition residues. Although the binder decomposition temperature may vary depending on the type of a binder, it may be set in the range of 200° C. to 900° C., preferably in the range of 300° C. to 500° C., e.g., to 450° C.

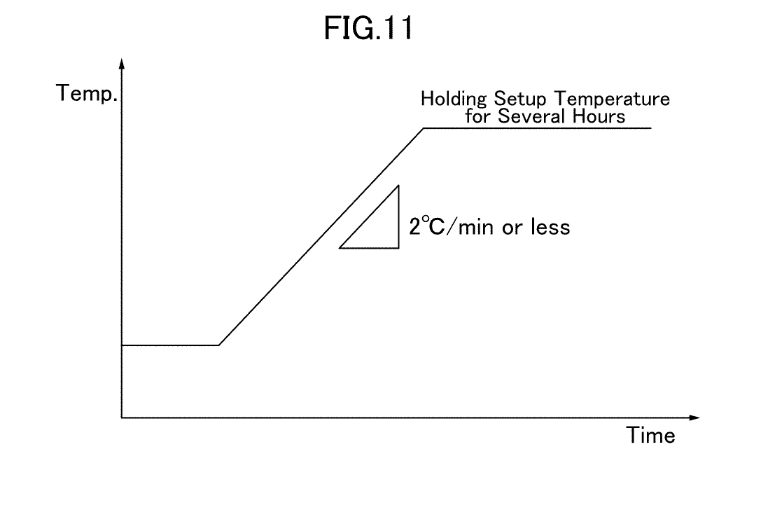

In the above calcining treatment, it is preferable to control a temperature rising speed to a smaller value, as compared to typical sintering treatment of a rare-earth magnet. Specifically, the temperature rising speed may be controlled to 2° C./min or less, e.g., 1.5° C./min. In this case, a good result can be obtained. Thus, the calcining treatment is performed such that a calcining temperature is increased at a given temperature rising speed of 2° C./min or less as depicted in FIG. 11, and, after reaching a predetermined setup temperature, that is, the binder decomposition temperature, held at the setup temperature for several hours to several ten hours. As above, the temperature rising speed in the calcining treatment is controlled to a relatively small value, so that carbon in the entire sintering sheet piece 125 is removed in a step-by-step manner without being rapidly removed. This makes it possible to reduce an amount of residual carbon to a sufficient level to thereby increase the density of a permanent magnet-forming sintered body after sintering. That is, by reducing the amount of residual carbon, it is possible to reduce voids in a permanent magnet. When the temperature rising speed is set to about 2° ° C./min as mentioned above, the density of a permanent magnet-forming sintered body after sintering can be increased to 98% or more, for example, 7.40 g/cm³ or more, more preferably 7.45 g/cm³ or more, further preferably 7.50 g/cm³ or more. As a result, high magnet properties can expected in a magnet after magnetization.

Subsequently, a sintering treatment for sintering the sinter processing sheet piece calcined by the calcining treatment is performed. For the sintering treatment, it may be possible to adopt a non-pressure sintering process under a suction pressure atmosphere, however, in the preferred embodiment described herein, a uniaxial pressing-sintering method is adopted. The uniaxial pressing-sintering method comprises sintering the sinter processing sheet piece 125 while uniaxially pressing the sintering sheet piece 125 in the direction perpendicular to the sheet of the drawing of FIG. 10. In this method, the sinter processing sheet piece 125 is loaded in a sintering die (not depicted) with a cavity having the same shape as that shown by “124” in FIG. 10(b). Then, after closing the die, the sinter processing sheet piece is sintered while being pressed in the direction perpendicular to the sheet of FIG. 10, that is, the lengthwise direction of the sinter processing sheet piece 125. Specifically, a uniaxial pressing sintering process is adopted, by having the sinter processing sheet piece 125 sintered while being pressed in a direction which is perpendicular to the rotation axis of the rotor core 21 when the rare-earth permanent magnet produced from the sinter processing sheet piece 125 is inserted into the magnet receiving slot 24. As this pressing-sintering technique, it is possible to employ any heretofore-known techniques such as hot press sintering, hot isostatic press (HIP) sintering, ultrahigh pressure synthesis sintering, gas pressure sintering, and spark plasma sintering (SPS). In particular, it is preferable to employ a hot press sintering in which a pressure can be applied in a uniaxial direction. In the case where the sintering is conducted under a hot press sintering method, it is preferred that the pressure is adjusted in the range of for example 0.01 MPa to 100 MPa, the temperature being raised under an atmosphere of several Pa or lower to a temperature between 900° C. to 1000° C., for example to 940° C. at a temperature raising rate of 3° ° C./min. to 30° C./min. such as 10° ° C./min., and maintain at the temperature until the rate of change of the dimension in the direction of pressing in 10 seconds becomes 0. The time for maintaining the temperature is generally 5 minutes. Thereafter, the sintered sheet piece is cooled and heated again to a temperature in the range of 300° C. to 1000° C. and maintained under the temperature for 2 hours. With such a sintering process, it is possible to produce a sintered body 1 for forming a rare-earth permanent magnet in accordance with one embodiment of the present invention As described, with the uniaxial sintering process wherein the sinter processing sheet piece 125 is sintered while being pressed in the lengthwise direction, it is possible to avoid any possible risk of the orientation of the easy magnetization axes produced in the magnet material particles being changed during the sintering process. During the sintering process, substantially all of the resin material in the sinter processing sheet piece is dissipated so that the residual amount of resin material is very small, if any.

Through the sintering treatment, the magnet material particles are sintered together to form a sintered body, in a state wherein the resin material has been dissipated. Typically, through the sintering treatment, a rare-earth-rich phase having a high rare-earth concentration is melted and tends to fill spaces which had existed among the magnet material particles to thereby form a sintered body of a fine compositions comprising a primary phase and the rare-earth-rich phase.

In the case of the illustrated embodiment, the sintered body 1 for forming a rare-earth permanent magnet is inserted into the magnet receiving slot 24 of the rotor core 21 shown in FIG. 5, under a non-magnetized state. Thereafter, the sintered body 1 for forming a rare-earth permanent magnet inserted into the slot 24 is magnetized along the easy magnetization axes, i.e., the C-axes of the magnet material particles contained in the sintered body 1. Specifically, a plurality of sintered bodies 1 inserted into a plurality of slots 24 are subjected to a magnetization treatment so that N poles and S poles are alternately produced along the periphery of the rotor core 21. Thus, it is possible to produce a rare-earth permanent magnet from the sintered body 1. In magnetizing the sintered body 1 for forming a rare-earth permanent magnet, any of known devices such as magnetizing coils, magnetizing yokes, capacitor type magnetizing source may be used. Further, the sintered body may be magnetized prior to insertion into the slot 24, and the magnetized body may be inserted into the slot 24.

According to the method for producing a sintered body for forming a rare-earth permanent magnet described above, the magnet materials are mixed with a binder to form a compound which is then formed into a sheet and the sheet is subjected to a parallel magnetic field under a temperature higher than a softening temperature of the compound to thereby have the easy magnetization axes oriented under the parallel magnetic field with a high accuracy. Thus, it is possible to suppress deviations in the orientation directions and increase the magnet performance. Further, a mixture of the magnet material particles and a binder is used in the shaping process, there is no risk of the magnet material particles being turned after the orientation process, so that it is possible to further enhance the orientation accuracy as compared with a conventional particle press-sintering process. According to the method wherein a compound comprising a mixture of magnet material particles and a binder is subjected to a magnetic field application for the orientation, it is possible to increase as desired a number of turns of wires for passing current for producing a magnetic field, to provide a substantial value of magnetic field intensity in carrying out the orientation under a magnetic field, and can apply a static magnetic field for a long time, so that it is possible to realize a highly accurate orientation with less deviations. It should further be noted that by changing the direction of orientation as described with reference to the embodiments shown in FIGS. 4 to 9, it becomes possible to ensure a highly accurate orientation with less deviations.

The fact that highly accurate orientations with less deviations can be realized means that variations in shrinkage during the sintering process can also be minimized. As the result, it is possible to reduce the necessity for outer shape trimming after a sintering process, so that it can be expected that a highly efficient production can be realized. Further, in the magnetic field orientation process, a magnetic field is applied to a compound made of a mixture of the magnet material particles and a binder, and in the case of the embodiment shown and described with reference FIGS. 4 to 9, a shaped body to which a magnetic field is applied is thereafter deformed into a shape of final product. Therefore, the directions of orientations can be modified by deforming the compound to which a magnetic field has been applied, to thereby concentrate the orientation directions of the easy magnetization axes to a region where measures for preventing demagnetization. As a result, even in a case where orientation is applied with a complicated pattern, it is possible to accomplish a highly accurate orientation with less deviation.

In the rare-earth permanent magnet-forming sintered body obtained as described above, any deviation in the orientation angle can be as small as 16° or less, preferably equal to or less than 14.0°, more preferably 12.0° or less, further preferably 10.0° or less. It is possible to increase the residual magnetic flux density by maintaining the orientation angle deviation within the aforementioned range.

It is further possible make the rare-earth permanent magnet-forming sintered body described above to have at least two regions respectively having defined axis orientation angles different each other by 20° or more. As already stated with reference to FIG. 1(a)(b), the defined axis orientation angle is herein defined as a most frequently appearing orientation angle among orientation angles of a plurality of magnet material particles contained in a rectangular area containing equal to or more than 30, in any position in a plane containing a thickness direction and a cross-thickness direction taken with respect to a predefined reference line. The difference between the axis orientation angles in two areas is preferably 25° or more, more preferably 3025° or more, most preferably 3525° or more.

Further, in a case where the aforementioned two areas are selected as areas having a straight distance d between centers of the areas of 15 mm or less, the difference in the axis orientations in these two areas is preferably 15° or more, more preferably 20° or more, and further preferably 25° or more. It is further preferable that the aforementioned two areas are selected such that the distance d between the two areas is 10 mm or less, more preferably 5 mm or less, further preferably 5 mm. Specifically, the two areas are preferably selected such that the distance d is 8 mm.

In general, a rare-earth permanent magnet-forming sintered body has a tendency that the orientation is disordered in a larger extent in a region close to a surface, so that it is preferable for the purpose of eliminating such adverse effect to select the aforementioned two areas chosen for determining the difference in the axis orientation angles at a position which is at least 0.5 mm, more preferably 0.7 mm apart from a surface which is closest to the two areas.

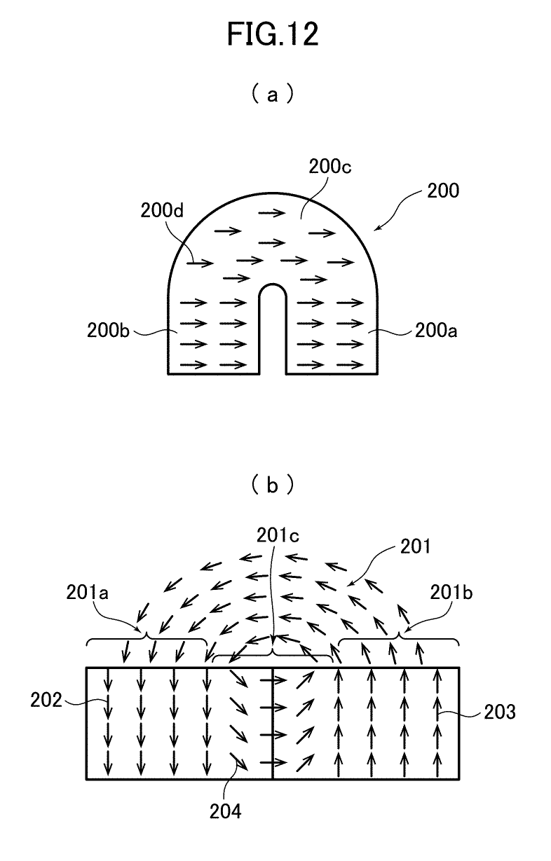

FIGS. 12(a)(b) are illustrations similar to FIGS. 10(a)(b) but showing another embodiment of the method in accordance with the present invention. As shown in FIG. 12(a), the first shaped body 200 formed from the green sheet 119 is of an inverted “U” shaped configuration including a pair of legs 200a and 200b, and a semi-circular portion 200c between the legs 200a and 200b, and the easy magnetization axes of the magnet material particles in the first shaped body 200 are oriented in parallel each other, through application of external parallel magnetic flux, as shown by an arrow 200d in FIG. 12(a) from left to right in the plane of the drawing. The first shaped body of an inverted U-shape is deformed under a predefined temperature condition into a straight configuration as shown in FIG. 12(b) to form a second shaped body 201. It is preferable that the deformation process from the first shaped body 200 to the second shaped body 201 is carried out in a several steps, such that in each step, a small amount of deformation takes place for preventing an excessive deformation at a time. For the purpose, it is preferable to provide a plurality of shaping dies each having a cavity corresponding to a deformation in each step, and carry out the forming process suitable for each step. It is to be noted that in the second shaped body 201 shown in FIG. 12(b), the easy magnetization axes of the magnet material particles in the second shaped body 201 have a parallel orientation in one end region 201a directed from upside to downside in the plane of the drawing as shown by an arrow 202 in FIG. 12(b), and a parallel orientation in the other end region 201b directed from downside to upside in the plane of the drawing as shown by an arrow 203 in FIG. 12(b). In a central region 201c between the end regions 201a and 201b, the orientation is in the form of an upwardly concave arc as shown by an arrow 204 in the drawing. In a rare-earth permanent magnet obtained by magnetizing the rare-earth permanent magnet-forming sintered body which has been prepared by sintering the second shaped body 201, there is produced a magnetic flux flow wherein magnetic flux exits from the upper surface of the one end region 201b, passes through an arcuate path and enters to the magnet at the upper surface of the other end region 201a. Therefore, in this magnet it is possible to produce a magnetic flux flow augmented at one surface of the magnet. Such magnet is appropriate for use in a linear motor.

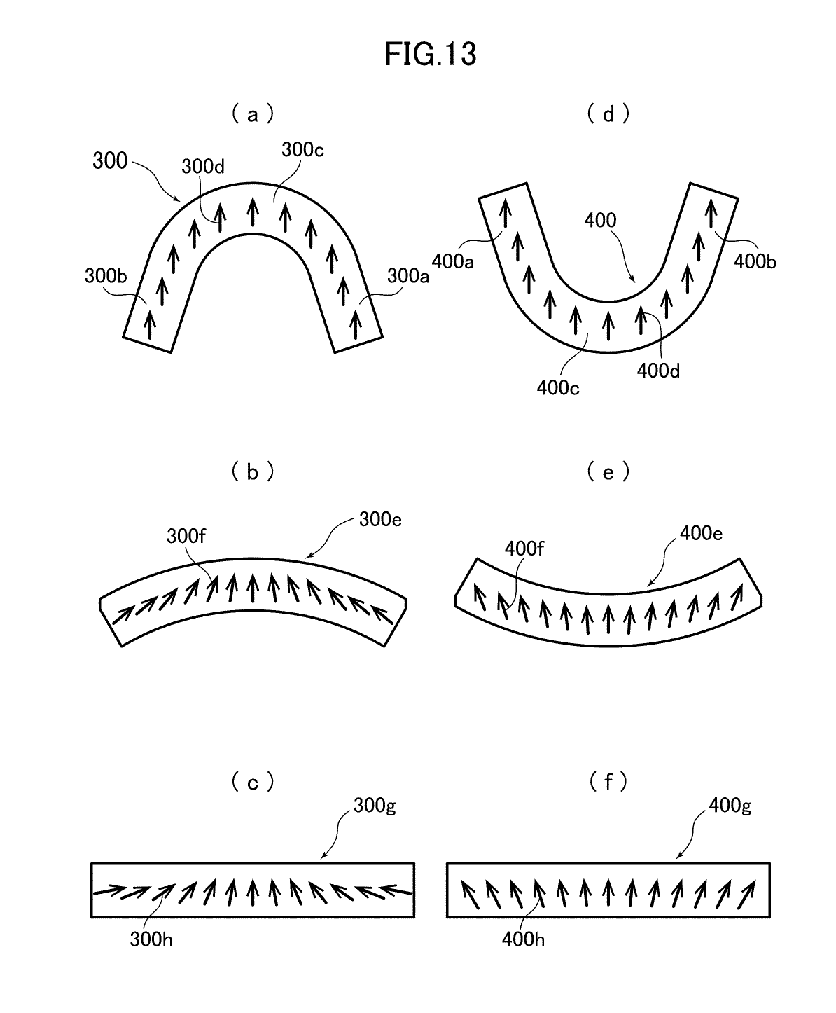

FIG. 13(a) shows a further embodiment of the present invention, including a first shaped body 300 has a configuration wherein, as compared with the inverted U-shape in the first shaped body 200 shown in FIG. 12(a), the space between a pair of legs 300a and 300b is widened at an end opposite to the semicircular portion 300c. The parallel magnetic flux is then directed from bottom to an upward direction. Thus, the easy magnetization axes of the magnet material particles contained in the first shaped body 300 are oriented in parallel upwardly from bottom as shown by an arrow 300d in FIG. 13(a). The first shaped body 300 is deformed into an arcuate shape shown in FIG. 13(b) to form a second shaped body 300e. Easy magnetization axes 300f of the magnet material particles are oriented as shown in FIG. 13(b) in a manner that the orientation angle is gradually increased toward the widthwise central region so that the orientation direction is concentrated toward the central portion. Thus, it is possible to produce a sintered body having orientations of the easy magnetization axes suitable for an arcuate magnet segment having polar anisotropy orientation. FIG. 10(c) shows a modification of the shaped body shown in FIG. 13(b), wherein a second shaped body 300g is formed from the first shaped body 300 by deforming it into an elongated parallelepiped shape. The orientations of the easy magnetization axes 300h of the modified second shaped body 300g are similar to those shown in FIG. 13(b). A magnet obtainable by magnetizing the sintered body which is produced by sintering the arcuate segment having a polar anisotropy orientations can be used for producing a Surface Permanent Magnet type (SPM) motor by arranging a plurality of such magnets on a peripheral surface of a rotor in a circumferential direction.

FIG. 13(d) shows a first shaped body 400 which is obtained by turning upside down the first shaped body 300 shown in FIG. 13(a) so as to have an open legged U-shape including a pair of legs 400a and 400b, and a semi-circular portion 400c between the legs 400a and 400b. The external parallel magnetic field is directed upwards from bottom. As a result, the easy magnetization axes of the magnet material particles contained in the first shaped body 400 have parallel orientations oriented from bottom upwards as shown by an arrow 400d in the drawing. In FIG. 13(e), there is shown a second shaped body 400e obtained by deforming the first shaped body 400 into a shape of an arc having a radius of curvature larger than that of the semi-circular portion 400c, the easy magnetization axes 400f of the magnet material particles contained in the second shaped body 400e have orientations spread from the widthwise central portion toward the end portions as shown in FIG. 13(e). FIG. 13(f) shows a second shaped body 400g which is a modification of the second shaped body shown in FIG. 13(e) and is deformed into an elongated parallelepiped configuration. The easy magnetization axes in the modified second shaped body 400g have orientations similar to those shown in FIG. 13(e).

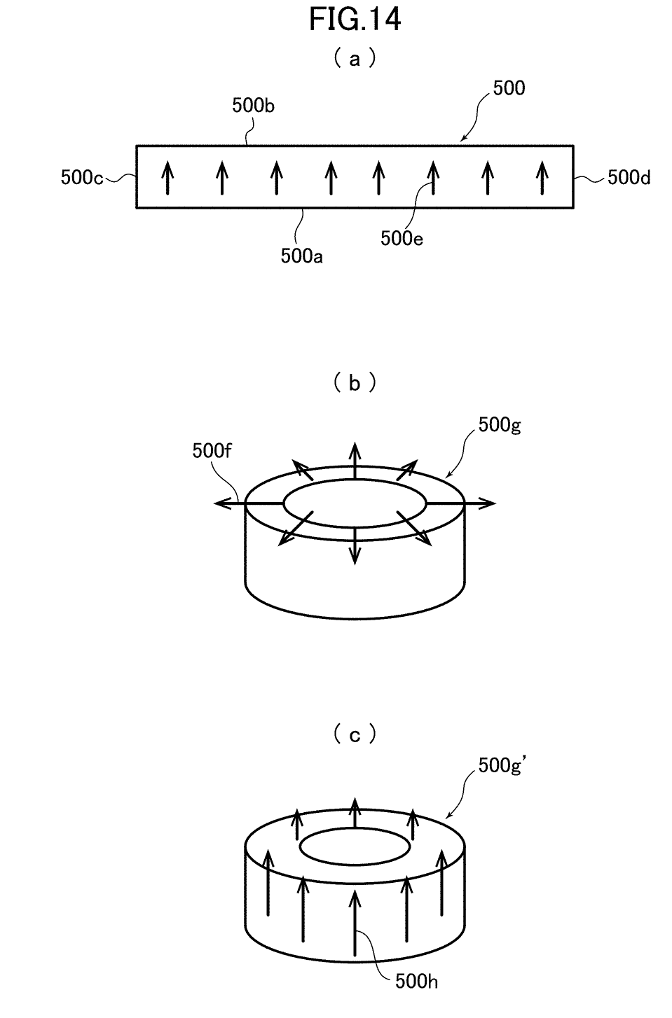

FIGS. 14(a)(b) are a side view and a perspective view, respectively, illustrating a method for producing a rear-earth magnet-forming sintered body of an annular configuration having radial orientation wherein easy magnetization axes of magnet material particles are oriented in radial directions. In FIG. 14(a), there is shown a first shaped body 500 which is substantially of a parallelepiped shape having a substantially rectangular cross-sectional configuration and a length in a direction perpendicular to the plane of the drawing, the first shaped body further having a lower surface 500a corresponding to the first surface, an upper surface 500b parallel to the lower surface 500a and corresponding to the second surface, and end surfaces 500c and 500d at the opposite end portions. An external parallel magnetic field is applied to the first shaped body 500 from bottom toward upward direction, whereby the easy magnetization axes of magnet material particles contained in the first shaped body 500 are oriented in parallel with each other in a direction from the lower surface 500a toward the upper surface 500b. The first shaped body 500 is bent into an annular shape with the upper surface 500b positioned radially outside and the lower surface 500a radially inside. In the bending process, the opposite ends surfaces 500c and 500d are brought into an abutting contact to form the annular shape. For the purpose, the opposite end surfaces 500c and 500d are cut to form slanted surfaces. The end surfaces 500c and 500d in abutting contact are then joined together through a melt joining technique. As the results of the bending and joining processes, a second shaped body 500g of an annular shape is produced as shown in FIG. 14(b). In the second shaped body 500g shown in FIG. 14(b) the easy magnetization axes 500f of the magnet material particles are directed in radial directions to provide a radial orientation. Referring now to FIG. 14(c), the first shaped body 500 shown in FIG. 14(a) is bent into an annular shape in a way that the portion extending perpendicularly to the plane of the drawing positioned radially inwards. In this case, the opposite end surfaces 500c and 500d are appropriately cut to form slanted surfaces so that they can be brought into an abutting contact to form the annular shape. The abutted end surfaces 500c and 500d are then joined by a melt joining technique. As the results of the bending and joining processes, an annular second shaped body 500g′ is formed as shown in FIG. 14(c). In the second shaped body 500g′ shown in FIG. 14(c), the easy magnetization axes 500h of the magnet material particles are directed in an axial direction to provide an axial orientation.

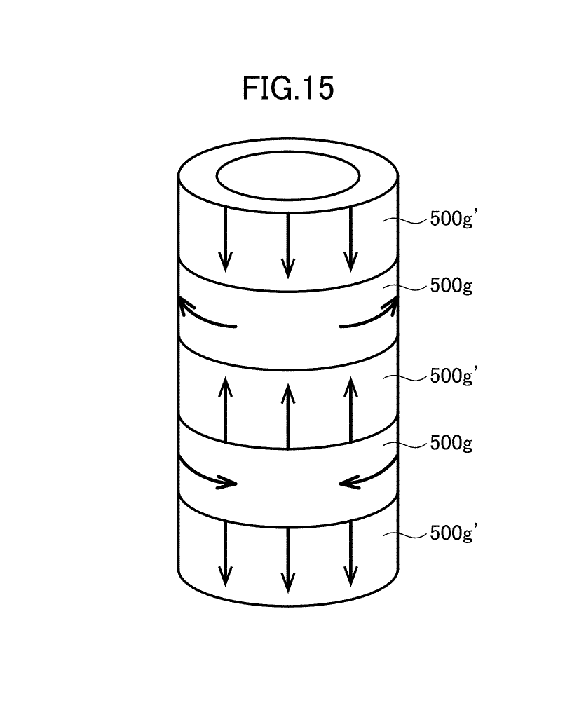

FIG. 15 depicts a magnet having a Halbach arrangement from rare-earth magnet-forming sintered bodies respectively obtained by sintering the second shaped bodies 500g each having an annular shape with the radial orientation of the easy magnetization axes and the second shaped bodies 500g′ each having an annular shape with the axial orientation of the easy magnetization axes. The sintered bodies are magnetized to produce respectively annular rare-earth permanent magnets having radial orientation and those having axial orientation. The annular magnets having radial orientation and those having axial orientation are arranged alternately as shown in FIG. 15. Annular magnets of Halabach arrangement are believed to have a prospective future particularly in applications for synchronized linear motor. For example, the U.S. Pat. No. 5,705,902 (Patent Document 10) discloses examples wherein magnets of this type are used in a series DC motor-generator, and JP 2013-215021A (Patent Document 11) discloses another application. However, in the past, it has not been easy to produce a radially oriented or axially oriented annular magnet stably with low cost. According to the method described above, it is possible to produce annular magnets respectively having radial and axial orientations of magnetization while providing high magnetic properties, in an easy manner.

The rare-earth magnet-forming sintered body described above is not limited to a manufacture of known magnet of parallel orientation of magnetization, but can be used to produce a magnet having any desired orientation and any desired shape. Thus, the rare-earth magnet-forming sintered body in accordance with anyone of the described embodiments, in a preferable aspect, can be the one which has orientations of easy magnetization axes significantly different from those of a radial-orientation annular magnet-forming sintered body which has magnet material particles totally oriented in radial directions. In a further preferable aspect, the embodiment of the present invention can provide a rare-earth magnet-forming sintered body having easy magnetization axes orientations and a shape which are significantly different from those in a radially oriented annular magnet and an annular magnet-forming sintered body wherein all of the magnet material particles are oriented in a manner of polar anisotropy.

### Examples

Hereinafter, examples of the present invention will be described in comparison with comparative examples and reference examples. In the inventive examples, the comparative examples and the reference examples, materials shown in Table 1 were used.

TABLE 1

| | | | Tg | Molecular |
|---|---|---|---|---|
| Material | Manufacturer | Product Name | (° C.) | Weight |
| 1-Octadecyne | Wako | — | 30 | |
| | Pharmaceutical | | | |
| 1-Octadecene | Wako | — | 15 | |
| | Pharmaceutical | | | |
| Oleyl Alcohol | Shin-Nippon | Rika-Cole 90B | 3 | |
| | Rika | | | |
| PIB | BASF | Oppanol B100 | −68 | 1.1 × 10⁶ |
| (Polyisobutylene) | | | | |
| PIB | BASF | Oppanol B150 | −68 | 2.6 × 10⁶ |
| (Polyisobutylene) | | | | |

### Example 1

A rare-earth permanent magnet having the configuration shown in FIG. 4 has been produced.

<Coarse Pulverization>

An alloy having an alloy composition A (Nd; 25.25 wt. %: Pr: 6.75 wt. %; B; 1.01 wt. %; Ga; 0.13 wt. %: Nb; 0.2 wt. %; Co: 2.0 wt. %; Cu; 0.13 wt. %; Al; 0.1 wt %; Fe; balance; other unavoidable impurities) was prepared by a strip casting method and had hydrogen absorbed in a room temperature. The hydrogen absorbed alloy composition was held under an atmosphere of 0.85 MPa for one day. Then, the alloy was subjected to a hydrogen pulverization treatment by holding it under an atmosphere of 0.2 MPa while cooling it by liquefied argon.

<Fine Pulverization>

100 weight parts of the coarse pulverized particles of the alloy was mixed with 1 weight part of hexanoic acid methyl and pulverized in a helium jet mill (PJM-80HE: available from NPK). The pulverized alloy particles were collected and classified by a cyclone collector, and excessively fine particles were removed. The pulverized alloy particles were supplied to the mill at a supply rate of 1 kg/h, with a supply of He gas at a pressure of 0.6 MPa, flow rate of 1.3 m³/min, oxygen concentration of 1 ppm or less, and a dew point of −75° C. or less. The magnet material particles after the fine pulverization had an average particle size of approximately 1.3 μm. The average particle size was measured by a laser diffraction/scatter type particle size distribution measuring device (LA950; available from HORIBA K.K.). Specifically, the fine pulverized particles were oxidized at a relatively slow oxidizing rate, and several hundred grams of the oxidized particles were uniformly mixed with silicon oil (KF-96H-Million cs; available from Shinetsu Kagaku K.K.) to form a paste. The paste was then placed between a pair of quartz glass plates to provide a test specimen. (HORIBA Paste Method)

A graph was provided to designate particle size distribution (volume %) and a value D50 in the graph was taken as the average particle size. In the case where the particle size distribution has two or more peaks, the value D50 was taken only for the peak value having smaller particle size to determine the average particle size.

<Kneading>

weight parts of 1-octene was added to 100 weight parts of the pulverized alloy particles and agitated in a mixer (TX-0.5; by Inoue Seisakusho) under an elevated temperature of 60° C. for 1 hour. Thereafter, the 1-ocitene and its reactant were evaporated under a suction pressure and an elevated temperature, and de-hydrogen processing was conducted. Then, 0.8 weight parts of oleyl alcohol, 4.1 weight parts of 1-octadecene, and 50 weight parts of a toluene solution (10 weight %) of polyisobutylene (PIB) B100 were added and agitated under a condition of suction pressure and an elevated temperature of 70° C. to remove toluene. Thereafter, a further kneading was carried out for 2 hours, to produce a clayey compound.

<Orientation Under Magnetic Field>

The compound prepared by the kneading process was brought into a corrosion resistant steel (SUS) die having a cavity of a shape similar to that shown in FIG. 10(a) to form a first shaped body (shaping process sheet) which was then subjected to an orientation process by applying an external parallel magnetic field using a super conductive solenoid coil (Trade Name: JMTD-12T100 manufactured by JASTEC Co.). The orientation process was carried out under a temperature of 80° C. for 10 minutes while applying an external parallel magnetic field of an intensity of 7 T in a direction parallel to the direction of the smallest side which is the thickness direction of the trapezoidal shape of the cavity. The solenoid coil was then taken out while maintaining the temperature of the shaped body at the orientation temperature. Then, a de-magnetizing treatment was carried out after removing the solenoid coil by applying to the shaped body a reverse magnetic field. The application of the reverse magnetic field was carried out by changing the intensity from −0.2 T to +0.18 T and then to −0.16 T and the magnetic field was gradually decreased to an intensity of 0.

<Deforming Process>

Subsequent to the orientation process, the shaped body (shaping process sheet) of the compound was taken out of the die and brought into an intermediate shaping die of corrosion resistant steel (SUS) having an end arcuate shape which is shallower than that shown in FIG. 10(a). The shaping process sheet was then subjected to a deforming process by pressing the sheet in the intermediate shaping die under a temperature of 60° C. Further, the formed shaping process sheet was taken out of the intermediate shaping die and brought into a final shaping die of corrosion resistant steel (SUS) having a cavity shape shown in FIGS. 10(b) and (c). A final shaping was conducted by pressing the shaping process sheet in the die under a temperature of 60° C.

<Calcining Process (De-Carbonize)>

A de-carbonizing process was applied to the formed shaping process sheet under a hydrogen atmosphere of 0.8 MPa. In this process, the temperature was raised from the room temperature to 370° C. at a raising rate of 0.8° C./min and the sheet was maintained under 370° C. for 3 hours. The hydrogen flow rate in this process was 2 to 3 L-min.

<Sintering>

Subsequent to the de-carbonizing process, a sintering process was carried out under a suction pressure by raising the temperature to 980° C. at a raising rate of 8° C./min and holding at this temperature for 2 hours.

<Annealing>

The sintered body obtained by the sintering process was subjected to an annealing process by raising the temperature from the room temperature to 500° C. at a raising rate wherein the temperature is reached in 0.5 hour. The sintered body was held under the temperature for 1 hour and rapidly cooled to form a sintered body for forming a rare-earth magnet.

### Example 2

A rare-earth magnet-forming sintered body was produced with processes similar to the Example 1 except conditions shown in Tables 2 and 3 were adopted. The Examples 1 and 2 were different only in the thickness of the trapezoidal magnet.

### Example 3

In the Example 3, the fine pulverizing process was conducted in a ball mill and a de-oiling process was carried out after the deforming process. Further, an under-pressure sintering process was adopted. In the followings, processes after the ball mill pulverization in the Example 3 will be described.

<Pulverization>

100 weight parts of the coarse particles of the alloy which was obtained through the hydrogen pulverization treatment was mixed with 1500 weight parts of Zr beads having diameter of 2 mm, and introduced into a ball mill having a tank of a capacity of 0.8 L (Atrita 0.8 L) obtainable from Nippon Cokes K.K. The ball mill was operated for 2 hours with a rotational speed of 500 rpm. Benzene was added in the amount of 10 wt. parts and liquefied argon was used as a solvent.

<Kneading>

The de-hydrogen treatment with the 1-octene was not adopted, but the pulverized alloy particles were mixed with 6.7 weight parts of 1-octadecine and 50 weight parts of a 8 wt. % toluene solution of poly-isobutylene. The mixture was brought into a mixer (Trade Name: TX-0.5 manufactured by Inoue Works) and agitated in the mixer under a reduced circumferential pressure at 70° C. to remove toluene. Then, the mixture was kneaded in the mixer under a reduced pressure for 2 hours to produce a clayey compound.

<Orientation by Magnetic Field>.

The compound prepared by the kneading process was brought into a corrosion resistant steel (SUS) die having a cavity of a shape similar to that shown in FIG. 10(a) and then subjected to an orientation process using a super-conductive solenoid coil (Trade Name: JMTD-12T100 manufactured by JASTEC Co.). The orientation process was carried out by applying an external parallel magnetic field of an intensity of 7 T in a direction parallel to thickness direction which is the side of smallest dimension of the trapezoidal shape of the cavity. The solenoid coil was then taken out while maintaining the temperature of the shaped body. Then, a de-magnetizing treatment was carried out after removing the solenoid coil by applying to the shaped body a reverse magnetic field. The application of the reverse magnetic field was carried out by changing the intensity from −0.2 T to +0.18 T and then to −0.16 T and the magnetic field was gradually decreased to an intensity of 0.

<Deforming Process>

Subsequent to the orientation process, the shaped body (shaping process sheet) of the compound was taken out of the die and brought into an intermediate shaping die of corrosion resistant steel (SUS) having an end arcuate shape shallower than that shown in FIG. 10(a). The shaping process sheet was then subjected to a deforming process by pressing the sheet in the intermediate shaping die under a temperature of 60° C. Further, the formed shaping process sheet was taken out of the intermediate shaping die and brought into a final shaping die of corrosion resistant steel (SUS) having a cavity shape shown in FIGS. 10(b) and (c). A final shaping was conducted by pressing the shaping process sheet in the die under a temperature of 60° C. The shaped sheet was taken out of the final shaping die of corrosion resistant steel (SUS) and put into a graphite die having a cavity identical in shape to that shown in FIG. 10(b). The graphite die was of a widthwise dimension that is a dimension perpendicular to the sheet of the drawing of FIG. 12(c) which was larger than a corresponding dimension of the shaped trapezoidal compound by approximately 20 mm. The shaped compound was inserted into the cavity of the graphite die such that the compound is positioned in the central portion of the graphite die. The graphite die was in advance applied with powder of BN (boron nitride) as a remover.

<De-Oil Process>

A de-oiling process was applied to the compound in the graphite die under a suction pressure. A rotary pump was used for evacuation. The temperature was raised from a room temperature to 100° C. at a temperature increasing rate of 0.9° C./min. and maintained at 100° C. for 60 hours. With this process, it is possible to remove any oil components such as lubricant for orientation and plasticizer by evaporation.

<Calcining Process (De-Carbonize)>

A de-carbonizing process was applied to the shaping process sheet after the de-oil process under a hydrogen atmosphere of 0.8 MPa. In this process, the temperature was raised from the room temperature to 370° C. at a raising rate of 2.9° C./min and the sheet was maintained under 370° C. for 2 hours. The hydrogen flow rate in this process was 2 to 3 L/min for a pressurized tank of approximately 1 litter.

<Sintering>

Subsequent to the de-carbonizing process, a sintering process was carried out under pressure, by inserting a pressing die having a sectional configuration identical to the cavity configuration shown in FIG. 10(b) into the graphite die. The pressing direction was perpendicular to the oriented direction of the easy magnetization axes (C-axes) of the magnet material particles, that is, the direction parallel to the widthwise direction of the compound sheet. During the sintering process, an initial load of 0.37 MPa was applied and the temperature was raised to 700° C. at a raising rate of 19.3° C./min. Thereafter, the temperature was raised to 950° C. at a raising rate of 7.1° C./min under a pressure of 9.2 MPa. The process sheet was maintained at the temperature of 950° C. for 5 minutes.

TABLE 2

| | | De-Oil Process | | | Calcining Process | | |
|---|---|---|---|---|---|---|---|
| | | Final | Raising | | Final | Raising | |
| | | Temp. | Rate | Holding | Temp. | Rate | Holding |
| | Pulverization | (° C.) | (° C./min) | Time (h) | (° C.) | (° C./min) | Time (h) |
| Example 1 | Jet Mill | — | — | — | 370 | 0.82 | 3 |
| Example 2 | Jet Mill | — | — | — | 370 | 0.82 | 3 |
| Example 3 | Ball Mill | 100 | 0.91 | 60 | 370 | 2.9 | 2 |

| | Sintering Process | | | | | |
|---|---|---|---|---|---|---|
| | Initial | Raising Rate | | Final | Raising Rate | |
| | Load | up to 700° C. | Load after | Temp. | After 700° C. | Hold |
| | (MPa) | (° C./min) | 700° C. (MPa) | (° C.) | (C./min) | (min) |
| Example 1 | 0 | 8 | 0 | 980 | 8 | 120 |
| Example 2 | 0 | 8 | 0 | 980 | 8 | 120 |
| Example 3 | 0.37 | 19.3 | 9.2 | 950 | 7.1 | 5 |

TABLE 3

| | | Wt. | Orientation | Wt. | | Wt. |
|---|---|---|---|---|---|---|
| | Polimer | Parts | Lubricant | Parts | Plasticizer | Parts |
| Example 1 | PIB | 50 | Oleyl | 0.8 | 1- | 4.1 |
| | B100 | | Alcohol | | Octadecene | |
| | 10 wt. % | | | | | |
| | Toluene | | | | | |
| | Solution | | | | | |
| Example 2 | PIB | 50 | Oleyl | 0.8 | 1- | 4.1 |
| | B100 | | Alcohol | | Octadecene | |
| | 10 wt. % | | | | | |
| | Toluene | | | | | |
| | Solution | | | | | |
| Example 3 | PIB | 50 | 1- | 6.7 | | |
| | B150 | | Octadecyne | | | |
| | 8 wt. % | | | | | |
| | Toluene | | | | | |
| | Solution | | | | | |

<Sintered Particle Size>

The surface of the sintered body thus obtained was subjected to a surface treatment by a SiC paper polishing, buffing, and milling. Then the sintered body was analyzed using an SEM (Trade Name: JSM-7001F by Nippon Eletron) incorporated with EBSD detector (Trade Name: AZtecHLK EBSD Nordlys Nano Integrated by Oxford Instruments). Alternatively, for the measurement, it is possible to use a SEM (SUPRA40VP by Zeiss) incorporated with an EBSD detector manufactured by EDAX (Hikari High Speed EBSD Detector). The angle of sight was determined such that at least 200 pieces of particles are included in the field of view. The analyzing step was 0.1 to 1 nm.

The data for analysis was analyzed using Cannel 5 (by Oxford Instruments) or OIM analyzing software version 5.2 (by EDAX). In determining boundary of the particles, a portion having 2° or more of deviation angle in orientation of crystal is considered as a boundary layer. Only particles in primary phase were extracted and circle-equivalent diameters of the particles were measured and an average of the measured circle-equivalent diameters was calculated to obtain the sintered particle size or diameter.

<Measurement of Half-Value Width of Axis Orientation Angle Deviation>

The orientation angle of the easy magnetization axes in the sintered body thus obtained was subjected to a surface treatment by a SiC paper polishing, buffing, and milling. Then the sintered body was analyzed using an SEM (Trade Name: JSM-7001F by Nippon Eletron) incorporated with EBSD detector (Trade Name: AZtecHLK EBSD Nordlys Nano Integrated by Oxford Instruments). Alternatively, for the measurement, it is possible to use a SEM (SUPRA40VP by Zeiss) incorporated with an EBSD detector manufactured by EDAX (Hikari High Speed EBSD Detector). The EBSD analysis was conducted with an angle of sight of 35 μm and 0.2 μm pitch. The analysis was conducted such that at least 30 sintered particles were contained in the range of the sight for the purpose of enhancing the analysis accuracy.

In the present embodiment, the sintered magnet of a trapezoidal shape was cut at the lengthwise center thereof, and measurement was conducted. The analysis was made at three positions along a thickness center line on the trapezoidal section, including positions close to the left and right ends and the center.

In each of the measurement positions, the direction of axis orientation of the particular measurement position was determined as a direction along which orientations of the easy magnetization axes appear most frequently. The angle of the orientation axis is defined with respect to a reference plane. In the analysis, a plane containing the A2 and A3 axes is defined on a bottom surface of the trapezoidal configuration, and this plane was selected as the reference plane for determining the angle of the orientation axis. Specifically, an inclination angle α measured from the A1 axis toward the A3 axis, and an inclination angle (θ+β) from the A1 axis toward the A3 axis were measured for determining the axis orientation angle. In the plane containing the A1 and A2 axes, the predefined orientation angle of the easy magnetization axis shall always be in the plane of the A1 and A2 axes at any measuring position. Therefore, the inclination angle α is an angular deviation from the predefined defined direction, or a “deviation angle”. The angle θ associated with the angle β represents a design value of angle between the orientation of the easy magnetization axis in the position of analysis and the A1 axis. Therefore, the angle β indicates a deviation of the orientation from the predefined direction, or a “deviation angle” in the position of analysis. An orientation angle difference between two orientation vectors which have largest orientation angle difference among respective positions of analysis (in the present embodiment, the orientation vector in the position close to the left end of the trapezoidal configuration and that in the position close to the left end of the trapezoidal configuration) was determined to calculate an axis orientation angle difference φ (0°≤φ≤90°).

In the EBSD analysis at each position of analysis, the direction of the orientation vector was calibrated to 0°, and thereafter, the deviation angle from the 0° direction of the orientation of the easy magnetization axis of each of the magnet material particles was calculated. An accumulated number of particles was calculated depending on the value of the deviation angle, and plotted in a graph. An angle in which the number of occurrence or the accumulated number reaches 50% is determined as the “half-width” angle of the axis orientation angle deviation Δθ.

<Aspect Ratio of the Sintered Particle>

The aspect ratio of the sintered particles in the sintered body was analyzed. For the purpose, the surface of the sintered body thus obtained was subjected to a surface treatment by a SiC paper polishing, buffing, and milling. Then the sintered body was analyzed using an SEM (Trade Name: JSM-7001F by Nippon Eletron) incorporated with EBSD detector (Trade Name: AZtecHLK EBSD Nordlys Nano Integrated by Oxford Instruments). Alternatively, for the measurement, it is possible to use a SEM (SUPRA40VP by Zeiss) incorporated with an EBSD detector manufactured by EDAX (Hikari High Speed EBSD Detector). The angle of sight was determined such that at least 200 pieces of particles are included in the field of view. The analyzing step was 0.1 to 1 μm.

The data for analysis was analyzed using Cannel 5 (by Oxford Instruments). In determining boundary of the particles, a portion having 2° or more of deviation angle in orientation of crystal is considered as a boundary layer and the data for analysis was processed and particle boundary extraction image was produced. The particle boundary extraction image was investigated by ImageJ (by Wayne Rasband) to obtain several images of rectangular areas which circumscribes each particle. Each of the rectangular areas was used to determine the longest side “a” and the shortest side “b”. Then average values of the longest side “a” and the shortest side “b” were calculated and based on the result of the calculation the aspect ratio “a/b” was calculated.

Results of evaluation of the Examples 1 to 3 thus obtained are shown in Table 4.

TABLE 4

| | Axis Orientation Angle | | | | | | Axis | | | | | Aspect |
|---|---|---|---|---|---|---|---|---|---|---|---|---|
| | Left End | | Center | | Right End | | Orientation | Half-Width Value of | | | | Ratio |
| | Slanted | Slanted | Slanted | Slanted | Slanted | Slanted | Angle | [symbol] θ (°) | | | Sintered | of |
| | Angle | Angle | Angle | Angle | Angle | Angle | Deviation | Left | | Right | Particle | Sintered |
| | α (°) | θ + β (°) | α (°) | θ + β (°) | α (°) | θ + β (°) | ϕ (°) | End | Center | End | Size (μm) | Particles |
| Example 1 | 0 | 25 | −3 | −5 | −3 | −22 | 47 | 12.3 | 11.3 | 10.3 | 0.9 | 1.6 |
| (Non-Pressure | | | | | | | | | | | | |
| Sintering) | | | | | | | | | | | | |
| Example 2 | −5 | 21 | −3 | 2 | −3 | −17 | 38 | 12.1 | 10.6 | 11 | 0.9 | 1.6 |
| (Non-Pressure | | | | | | | | | | | | |
| Sintering) | | | | | | | | | | | | |
| Example 3 | −2 | 17 | −1 | 0 | −3 | −28 | 45 | 15.2 | 15.7 | 15 | 0.9 | 1.6 |
| (Sintering) | | | | | | | | | | | | |

It has been confirmed that in either of the Examples 1 to 3, the directions of the orientation vectors are concentrated toward the center of the trapezoidal configuration as expected, due to the bending or deformation of the compound. The angle φ in each position of analysis was different by at least 20° from that in the other position of analysis to realize a non-parallel orientation. Further, the angle difference Δθ at the value of the “half-width” which is an indication of the axis orientation angle deviation is around 10° to 16°. Thus, the magnets of the Examples 1 to 3 have non-parallel orientation of magnetization but have small deviation from the defined orientation.

### Example 41

<Coarse Pulverizaion>

An alloy having an alloy composition as in the Example 1 was prepared by a strip casting method and had hydrogen absorbed in a room temperature. The hydrogen absorbed alloy composition was held under an atmosphere of 0.85 MPa for one day. Then, the alloy was subjected to a hydrogen pulverization treatment by holding it under an atmosphere of 0.2 MPa while cooling it.

<Fine Pulverization>

100 weight parts of the coarse pulverized particles of the alloy was mixed with 1 weight part of hexanoic acid methyl and pulverized in a helium jet mill (PJM-80HE: available from NPK). The pulverized alloy particles were collected and classified by a cyclone collector, and excessively fine particles were removed. The pulverized alloy particles were supplied to the mill at a supply rate of 1 kg/h, with a supply of He gas at a pressure of 0.6 MPa, flow rate of 1.3 m³/min, oxygen concentration of 1 ppm or less, and a dew point of −75° C. or less. The magnet material particles after the fine pulverization had an average particle size of approximately 1.2 μm. The average particle size was measured as described with reference to the Example 1.

<Kneading>

40 weight parts of 1-octene was added to 100 weight parts of the pulverized alloy particles and agitated in a mixer (TX-0.5: by Inoue Seisakusho) under an elevated temperature of 60° C. for 1 hour. Thereafter, the 1-ocitene and its reactant were evaporated under a suction pressure and an elevated temperature, and de-hydrogen processing was conducted. Then, 1.7 weight parts of 1-octadecyne, 4.3 weight parts of 1-octadecene, and 50 weight parts of a toluene solution (8 weight %) of polyisobutylene (PIB) B100 were added to the alloy particles and agitated under a condition of suction pressure and an elevated temperature of 70° C. to remove toluene by evaporation. Thereafter, a further kneading was carried out for 2 hours, to produce a clayey compound.

<Formation of First Shaped Body>

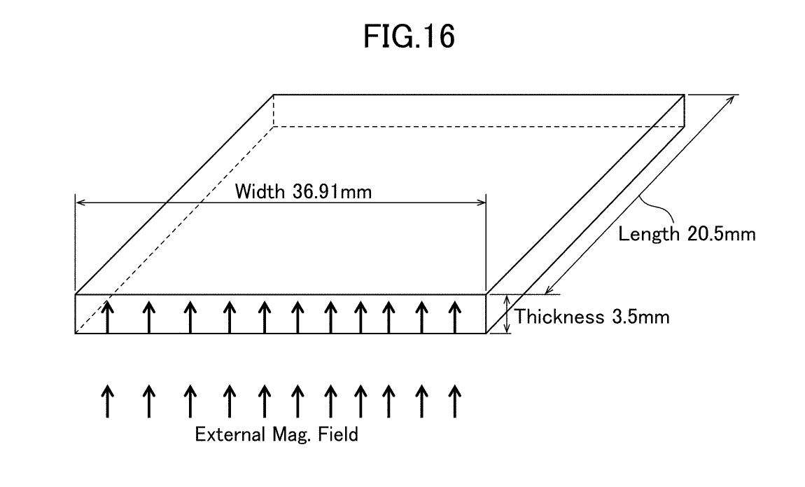

The compound produced by the kneading process described above was charged into a corrosion resistant steel (SUS) die having a cavity of a configuration similar to that shown in FIG. 16 to form a first shaped body of a flat panel shape.

<Orientation under Magnetic Field>

The corrosion resistant steel die having the first shaped body charged therein was then applied with an external parallel magnetic field in the direction shown in FIG. 16 using a super conductive solenoid coil (Trade Name: JMTD-7T200 manufactured by JASTEC Co.) to thereby carry out an orientation processing. The orientation process was carried out by passing the corrosion resistant steel (SUS) die having the first shaped body charged therein and heated to a temperature of 80° C., through a super conductive solenoid coil having an axial length of 2000 mm at a speed with which the die is passed through the coil in 10 minutes, while applying an external parallel magnetic field of an intensity of 7 T. Then, a de-magnetizing treatment was carried out by applying a magnetic field to the corrosion resistant steel (SUS) die using a pulse type de-magnetization device (MFC-2506D by Magnet Force Co.).

<Formation of Second Shaped Body>

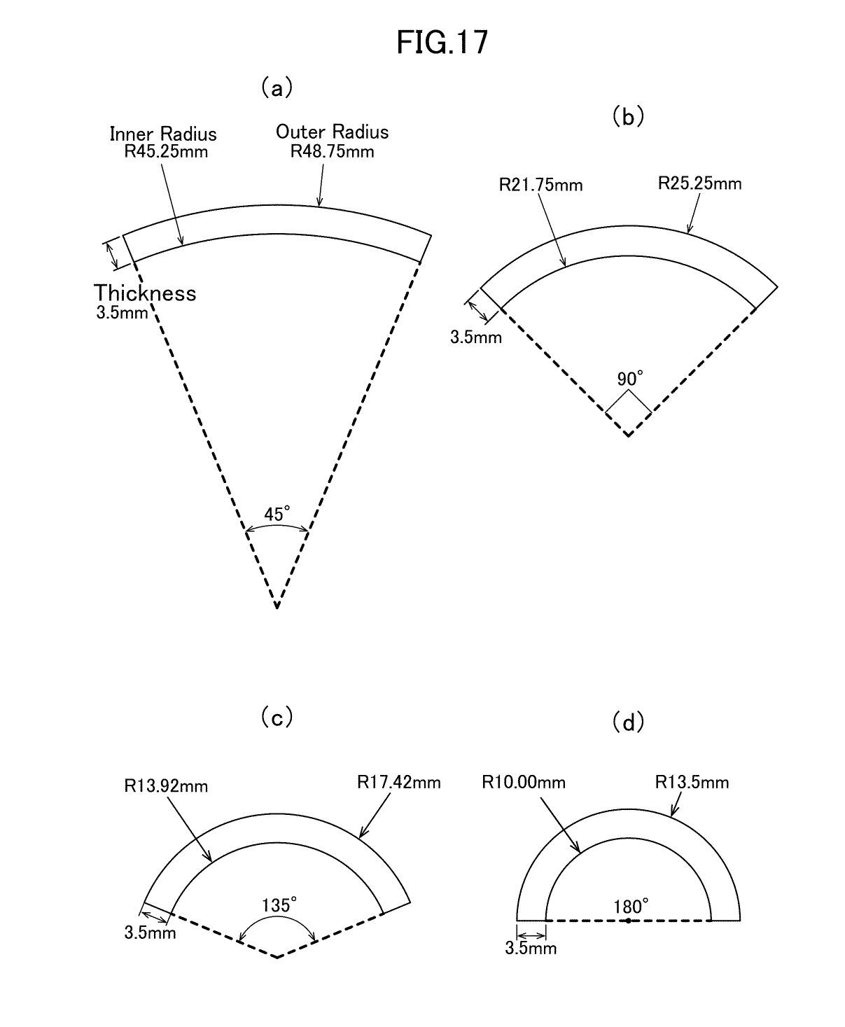

Subsequent to the de-magnetization process described above, the first shaped body (shaping process sheet) was taken out of the corrosion resistant steel (SUS) die and brought into a female die of corrosion resistant steel (SUS) which has a cavity of an arcuate shape having a radius of curvature of 48.75 mm. Then, the first shaped body in the female die was pressed by a male die having an arcuate shape of a radius of curvature of 45.25 mm to have the first shaping die deformed into a first intermediate shaped body as shown in FIG. 17(a). The first intermediate shaped body was then transferred into a second female die having a cavity of an arcuate shape with a radius of curvature of 25.25 mm, and pressed by a male die having an arcuate shape of radius of curvature of 21.75 mm to be deformed into a second intermediate shaped body as shown in FIG. 17(b). Further, the second intermediate shaped body is brought into a male die having an arcuate cavity with a radius of curvature of 17.42 mm and pressed by a male die having an arcuate shape of a radius of curvature of 13.92 mm, to have the second intermediate shaped body deformed into a third intermediate shaped body as shown in FIG. 17(c). Thereafter, the third intermediate shaped body is introduced into a female die having an arcuate shape with a radius of curvature of 13.50 mm, and pressed by a male die having an arcuate shape with a radius of curvature of 10.00 mm, to have the third intermediate shaped body deformed into a second shaped body of a semi-circular shape as shown in FIG. 17(d). The aforementioned deformation processes for forming the intermediate shaped bodies and the second shaped body were conducted under a temperature condition of 70° C. in a manner that the thickness dimension did not change by the deformation.

<Calcining Process (De-Carbonize)>

A de-carbonizing process was applied to the second shaped body under a hydrogen atmosphere of 0.8 MPa under a temperature condition described hereinafter. In this process, the temperature was raised from the room temperature to 500° C. at a raising rate of 1.0° C./min and the second shaped body was maintained under 500° C. for 2 hours. During the process, hydrogen flow was maintained so that any dissolved substance of organic materials would not remain in the de-carbonizing vessel. The hydrogen flow rate was 2 L/min.

<Sintering>

Subsequent to the de-carbonizing process, the second shaped body was sintered under an atmosphere of reduced pressure. The sintering process was carried out by raising the temperature for 2 hours to 970° C. at a raising rate of 7.9° C./min and holding at the temperature of 970° C. for 2 hours.

<Annealing>

The sintered body obtained by the sintering process was subjected to an annealing process by raising the temperature from the room temperature to 500° C. at a raising rate wherein the temperature is reached in 0.5 hour. The sintered body was held under the temperature for 1 hour and rapidly cooled to form a semi-circular sintered body of a semi-annular shape for forming a rare-earth magnet.

<Measurement of Axis Orientation Angle and Deviation Angle>

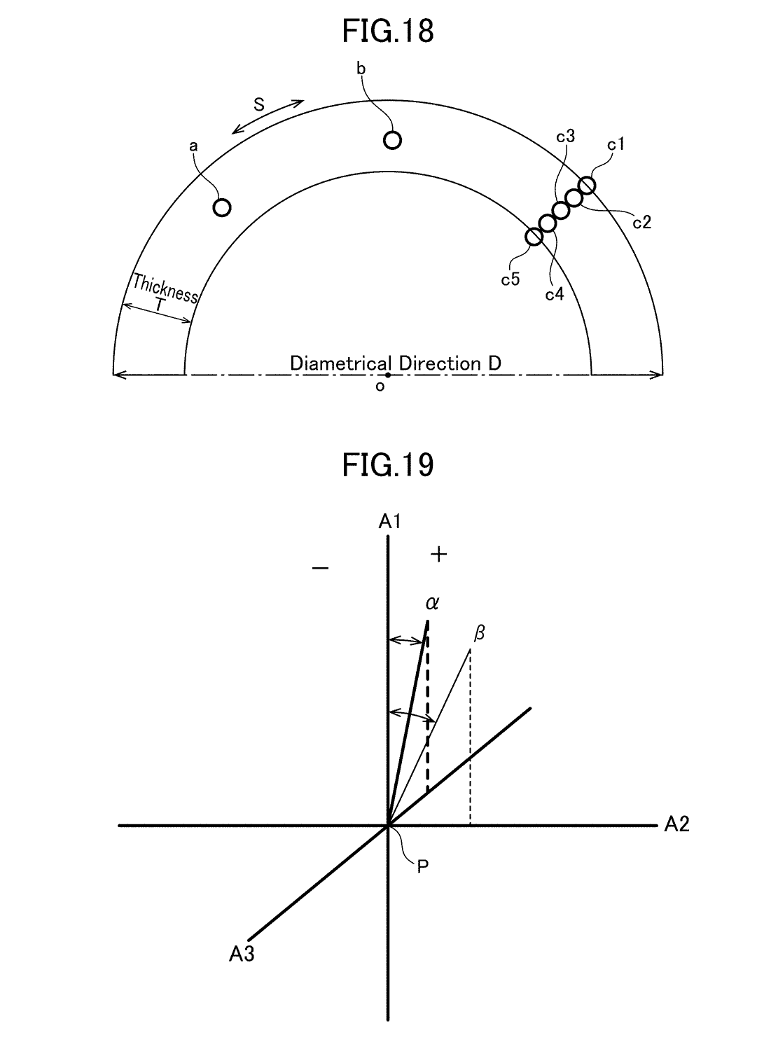

Measurements were conducted on the sintered body thus obtained with a method similar to that described with reference to the Example 1. In this example, however, the sintered body having an arcuate cross-section and a length wise direction perpendicular to the cross-section was cut in a widthwise direction at the lengthwise center to produce a section for measurement. In FIG. 18, there is shown a section of the semi-annular rare-earth magnet-forming sintered body on which the measurements were made. The sintered body has a diametrical direction D represented by a diametrical line connecting the opposite ends, a center O of radius of curvature of the arc, a thickness T of the sintered body taken along a diametrical direction, and a circumferential direction S. The direction perpendicular to the plane of the drawing is the lengthwise direction L.

Positions of measurements for obtaining axis orientation angles and axis orientation angle deviations are determined on a thickness center arcuate line drawn on the arcuate section along the center of the thickness T. and the measurement positions are taken on the thickness center arcuate line at three points which are quadrant positions of the thickness center arcuate line, namely, a middle point between circumferentially center point and a left end of the thickness center arcuate line (position “a” in FIG. 18), the circumferentially center point of the thickness center arcuate line (position “b” in FIG. 18), and a middle point between the circumferentially center point and a right end of the thickness center arcuate line (position “c3” in FIG. 18). Further, on a radial line passing through the measurement point c3 in FIG. 18, five positions were determined as the measurement positions. The five positions are a point on the radial line 300 μm radially inside from the convex surface of the arcuate section (position “c1” in FIG. 18), a middle point between the convex surface and the thickness center point c3 (position “c2” in FIG. 18), a middle point between the concave surface and the thickness center point c3 (position “c4” in FIG. 18), and a point on the radial line 300 μm radially outside from the concave surface of the arcuate section (position “c5” in FIG. 18).

In each of the measurement positions, an axis orientation direction was determined as a direction where crystal “C” axes (001) are oriented at most frequent occurrences. Referring to FIG. 19, in a plane containing the semi-circular arcuate section of the sintered body, there is defined a rectangular coordinates including an A1 axis passing from the center O of the curvature of the arc through the circumferentially center point of the thickness center arcuate line (position “‘b’” in FIG. 18), an A2 axis which is a radial line extending through the center O of the curvature of the arc and orthogonal to the A1 axis, and an A3 axis extending through the center O in a direction orthogonal to both the A1 and A2 axes and extending in a lengthwise direction of the sintered body. A plane containing the A2 and A3 axes is determined as a reference plane. In the rectangular coordinates, measurements were made on an inclination angle α which was a direction of orientation of the easy magnetization axis from the A1 axis toward the A3 axis, and an inclination angle (θ+β) which was a direction of orientation of the easy magnetization axis from the A1 axis toward the A2 axis. In the plane containing the A1 and A2 axes, the predefined orientation angle of the easy magnetization axis shall always be in the plane of the A1 and A2 axes at any measuring position. Therefore, the inclination angle α is an angular deviation from the predefined defined direction, or a “deviation angle”. The angle θ associated with the angle β represents a design value of angle between the orientation of the easy magnetization axis in the position of analysis and the A1 axis. Therefore, the angle β indicates a deviation of the orientation from the predefined direction, or a “deviation angle” in the position of analysis.

In each measurement position, measurements on the axis orientations of the easy magnetization axes were made on more than a predetermined number of magnet material particles. It is preferable that the size of each measurement position is determined such that at least 30 magnet material particles are included, as the predetermined number, in the measurement position. In the present example, the size of the measurement position was determined to contain approximately 700 magnet material particles.

Further, in the EBSD analysis in each of the measurement positions, a base axis orientation in the measurement position was determined at 00, and thereafter, the deviation angle from the base axis orientation which was 0° direction of the orientation of the easy magnetization axis of each of the magnet material particles was calculated. An accumulated number of particles was calculated depending on the values of the deviation angles, and plotted in a graph. An angle in which the number of occurrence or the accumulated number reaches 50% is determined as the “half-width” angle of the axis orientation angle deviation Δθ. In each of the measurement positions, an axis orientation angle difference φ was also determined as angle difference having a largest value. The results are shown in Table 5.

TABLE 5

| | | | Axis Orientation | | | | Axis |
|---|---|---|---|---|---|---|---|
| | | | Angle | | | | Orientation |
| | | Half-Width | Slanted | Slanted | | | Angle |
| | Measurement | Value of | Angle | Angle | | | Deviation |
| | Positions | [symbol] θ (°) | α (°) | θ + β (°) | θ (°) | β (°) | ϕ (°) |
| Example 4 | a | 10.9 | 2 | −41 | −45 | 4 | 89 |
| | b | 11.1 | 0 | 0 | 0 | 0 | |
| | c3 | 11.1 | 3 | 46 | 45 | 1 | |
| | c1 | 9.0 | 4 | 45 | 45 | 0 | |
| | c2 | 10.2 | 3 | 46 | 45 | 1 | |
| | c4 | 9.7 | 2 | 46 | 45 | 1 | |
| | c5 | 11.0 | 2 | 48 | 45 | 3 | |

I has been confirmed that the value of the angle β in each of the measurement positions is not larger than 4°, and that a radial orientation sintered body was produced as designed. Further, the value of the “half-width” angle of the axis orientation angle deviation Δθ is at most 11.1, so that it has been confirmed that the sintered body has small value of deviation angle. Still further, it has been confirmed that a non-parallel orientation is accomplished since the axis orientation angle difference is 89°.

### Examples 5 to 9

Sintered bodies of the Examples 5 to 9 were produced with processes similar to the Example 4 except that the bending angle of the second shaped body, and the dimensions in the first shaped body, the first to third intermediate shaped bodies and the second shaped body were changed as shown in Table 6.

The deformation processes were conducted that in each deformation steps, a deformation of 45° was produced. In the Example 5, a first shaped body produced by a die shown in FIG. 16 was deformed to produce a 45° deformation as shown in FIG. 17(a) into an intermediate shaped body 1, and was further deformed to produce a 45° deformation as shown in FIG. 17(b) into a second shaped body as a result of total 90° of deformation. In the Example 7, a further deformation of 45° was applied to produce a second shaped body shown in FIG. 17(c). In the Examples 6, 8 and 9, a further deformation of 45° was applied to produce a second shaped body shown in FIG. 17(d). In addition, in the Example 9, the orientation process was carried out by applying an external parallel magnetic field by a super conductive solenoid coil (JMTD-12T100; by JASTEC). The orientation was conducted with a corrosion resistant steel (SUS) die having a compound charged therein, by heating the die to 80° C., and placing the die in the super conductive solenoid coil, and thereafter energizing the coil to increase the intensity from 0 T to 7 T in a time period of 20 minutes, then decrease the intensity to 0 T in a time period of 20 minutes. Thereafter, the die was de-magnetized by applying a magnetic field of a reverse polarity. The application of the magnetic field of reverse polarity was conducted by changing the intensity from −0.2 T to +0.18 T, and then to −0.16 T and finally to zero magnetic field intensity.

TABLE 6

| | | | | | Intermediate | | Intermediate | | Intermediate | | Second Shaped | |
|---|---|---|---|---|---|---|---|---|---|---|---|---|
| | | | | | Shaped Body 1 | | Shaped Body 2 | | Shaped Body 3 | | Body | |
| | Bending | First Shaped Body | | | Inner | Outer | Inner | Outer | Inner | Outer | Inner | Outer |
| | Angle | Thickness | Width | Length | Radius | Radius | Radius | Radius | Radius | Radius | Radius | Radius |
| | ° | mm | mm | mm | mm | mm | mm | mm | mm | mm | mm | mm |
| Example 4 | 180 | 3.5 | 36.91 | 20.0 | 45.25 | 48.75 | 21.75 | 25.25 | 13.92 | 17.42 | 10.00 | 13.50 |
| Example 5 | 90 | 3.5 | 36.91 | 20.0 | 45.25 | 48.75 | — | — | — | — | 21.75 | 25.25 |
| Example 6 | 180 | 5.0 | 39.27 | 20.0 | 47.50 | 52.50 | 22.5 | 27.5 | 14.17 | 19.17 | 10.00 | 15.00 |
| Example 7 | 135 | 5.0 | 39.27 | 20.0 | 47.50 | 52.50 | 22.5 | 27.5 | — | — | 14.17 | 19.17 |
| Example 8 | 180 | 3.5 | 21.21 | 15.00 | 25.25 | 28.75 | 11.75 | 15.25 | 7.25 | 10.75 | 5.00 | 8.75 |
| Example 9 | 180 | 3.5 | 11.78 | 10.00 | 13.25 | 16.75 | 5.75 | 9.25 | 3.25 | 6.75 | 2.00 | 5.50 |

The results of the evaluation of each sintered body are shown in Tables 7 and 8.

TABLE 7

| | | | Axis Orientation | | | | Axis |
|---|---|---|---|---|---|---|---|
| | | | Angle | | | | Orientation |
| | | Half-Width | Slanted | Slanted | | | Angle |
| | Measurement | Value of | Angle | Angle | | | Deviation |
| | Positions | [symbol] θ (°) | α (°) | θ + β (°) | θ (°) | β (°) | ϕ (°) |
| Example 5 | a | 9.4 | 2 | −23 | −23 | 0 | 41 |
| | b | 8.9 | −1 | −1 | 0 | −1 | |
| | c3 | 9.0 | 2 | 18 | 23 | −5 | |
| | c1 | 9.7 | 2 | 17 | 23 | −6 | |
| | c2 | 10.4 | 2 | 18 | 23 | −5 | |
| | c4 | 8.7 | 0 | 17 | 23 | −6 | |
| | c5 | 9.4 | 0 | 17 | 23 | −6 | |
| Example 6 | a | 8.9 | 2 | −49 | −45 | −4 | 85 |
| | b | 9.4 | 0 | −5 | 0 | −5 | |
| | c3 | 8.7 | 3 | 47 | 45 | 2 | |
| | c1 | 9.7 | −2 | 49 | 45 | 4 | |
| | c2 | 9.1 | 3 | 46 | 45 | 1 | |
| | c4 | 9.4 | 3 | 47 | 45 | 2 | |
| | c5 | 10.6 | 1 | 46 | 45 | 1 | |
| Example 7 | a | 8.4 | 0 | −33 | −34 | 1 | 66 |
| | b | 7.8 | 0 | −1 | 0 | −1 | |
| | c3 | 9.2 | 2 | 33 | 34 | −1 | |
| Example 8 | a | 8.9 | 0 | −48 | −45 | −3 | 83 |
| | b | 8.9 | 0 | 0 | 0 | 0 | |
| | c3 | 8.5 | 0 | 49 | 45 | 4 | |
| | c1 | 10.2 | 1 | 54 | 45 | 9 | |
| | c2 | 9.3 | 0 | 52 | 45 | 7 | |
| | c4 | 8.8 | 0 | 51 | 45 | 6 | |
| | c5 | 10.1 | 1 | 51 | 45 | 6 | |
| Example 9 | a | 14.8 | 5 | −38 | −45 | 7 | 86 |
| | b | 12.5 | 3 | 1 | 0 | 1 | |
| | c3 | 14.2 | 2 | 37 | 45 | −8 | |
| | c1 | 14.2 | 5 | 48 | 45 | 3 | |
| | c2 | — | — | — | — | — | |
| | c4 | — | — | — | — | — | |
| | c5 | 12.5 | 3 | 47 | 45 | 2 | |

TABLE 8

| | Sintered | Sintered | Amount | Amount | Amount | Amount |
|---|---|---|---|---|---|---|
| | Particle | Body | of | of | of | of |
| | Size | Density | Carbon | Oxygen | Hydrogen | Nitrogen |
| | μm | g/cm³ | (ppm) | (ppm) | (ppm) | (ppm) |
| Example 4 | 1.0 | 7.57 | 170 | 3000 | 780 | 190 |
| Example 5 | 1.0 | 7.57 | 360 | 2800 | 520 | 150 |
| Example 6 | 1.1 | 7.46 | 110 | 4000 | 1350 | 230 |
| Example 7 | 1.0 | 7.52 | 900 | 3400 | 610 | 210 |
| Example 8 | 1.0 | 7.55 | 230 | 4200 | 2300 | 190 |
| Example 9 | 1.0 | 7.55 | 210 | 4700 | 3000 | 220 |

TABLE 9

| | | | Distance to a |
|---|---|---|---|
| | d | ϕ | Closest Surface |
| | (mm) | (°) | (mm) |
| Example 1 | 9.0 | 30.1 | 0.8 |
| Example 2 | 9.2 | 19.1 | 1.0 |
| Example 3 | 4.2 | 17 | 0.9 |
| Example 4 | 8.2 | 41 | 1.2 |
| Example 5 | 7.8 | 22.2 | 1.2 |
| Example 6 | 8.3 | 44 | 1.7 |
| Example 7 | 8.3 | 32 | 1.7 |
| Example 8 | 4.4 | 48 | 1.2 |
| Example 9 | 2.7 | 39 | 1.4 |

It has been noticed that in the Examples 5 to 9 that the angle β is 9° at the largest, so that it has been confirmed that sintered bodies of radial orientations were obtained as designed. It has also been confirmed that either of the examples was of a non-parallel orientation having maximum axis orientation angle difference q of above 20°. The Example 9 shows an axis orientation angle deviation which is a little bit larger than the other examples, however, this is understood as having been caused by the difference in the orientation device. It can be considered that if a device similar to that used in the Examples 4 to 8 is used the axis orientation angle deviation in the Example 9 would be in the range of 8 to 11°.

The sintered body of the Example 9 was further investigated with SEM device, by cutting the sintered body at the lengthwise center. The section was observed to investigate a crack depth. It has been found that the maximum crack depth was 35 μm, so that it has been confirmed that crack was not essentially produced. The values of aspect ratio of the magnetic material particles were measured and it has been found that the measured values were less than 1.7.

In Table 9, there are shown results of the analysis in the respective measurement positions. In relation to the sintered bodies of a trapezoidal configuration in the Examples 1 to 3, the value “d” was taken as a straight distance between the measurement points at the left end and the central portion, and the axis orientation angle difference at the measurement point was taken as the value φ. In a case where there are two measurement positions, the value obtained at the position which is closer to a closest surface is shown in the table. In the Examples 4 to 9, the value “d” was taken as a straight distance between the measurement points “a” and “b”, and the axis orientation angle difference at the measurement point was taken as the value q. In a case where there are two measurement positions, the value obtained at the position which is closer to a closest surface is shown in the table.

### LIST OF REFERENCE SIGNS

1: rare-earth permanent magnet-forming sintered body
2: upper side
3: lower side
4, 5: end surface
6: central region
7, 8: end region
20: electric motor
21: rotor core
21a: peripheral surface
22: air gap
23: stator
23a: teeth
23b: field coil
24: magnet receiving slot
24a: straight central portion
24b: slanted portion
30: rare-earth magnet
117: compound
118: support substrate
119: green sheet
120: slot-die
123: process sheet piece
125: sintering process sheet piece
C: easy magnetization axis
θ: slanted angle

1. A rare-earth magnet-forming sintered body wherein a number of magnet material particles including rare-earth substances and each having an easy magnetization axis are integrally sintered;
the sintered body being of a parallelepiped three dimensional shape which has a lengthwise dimension in a lengthwise direction, a thickness dimension defined between a first surface and a second surface in a thickness direction in a section perpendicular to the lengthwise direction, and a cross-thickness dimension taken in a cross-thickness direction which is perpendicular to the thickness direction;
said sintered body further having at least two regions respectively having defined axis orientation angles different each other by 20° or more, the defined axis orientation angle being defined as a most frequently appearing orientation angle with respect to a predefined reference line, among orientation angles of a plurality of magnet material particles contained in a rectangular area in any position in a plane containing equal to or more than 30 of the magnet material particles;
wherein in each said rectangular area, an angular deviation of the orientation angle of each easy magnetization axis of each magnet material particle with respect to the axis orientation angle defined for the particular rectangular area is not larger than 16°.

2. A rare-earth magnet-forming sintered body wherein a number of magnet material particles including rare-earth substances and each having an easy magnetization axis are integrally sintered;
the sintered body being of a parallelepiped three dimensional shape which has a lengthwise dimension in a lengthwise direction, a thickness dimension defined between a first surface and a second surface in a thickness direction in a section perpendicular to the lengthwise direction, and a cross-thickness dimension taken in a cross-thickness direction which is perpendicular to the thickness direction;
said sintered body further having at least two regions respectively having defined axis orientation angles different each other by 20° or more, the defined axis orientation angle being defined as a most frequently appearing orientation angle with respect to a predefined reference line, among orientation angles of a plurality of magnet material particles contained in an area of a square shape having a dimension of each side of 35 μm in any position in a plane containing said thickness direction and said cross-thickness direction;
wherein in each said area of square shape, an angular deviation of the orientation angle of each easy magnetization axis of each magnet material particle with respect to the axis orientation angle defined for the particular area of square shape is not larger than 16°.

3. A rare-earth magnet-forming sintered body in accordance with claim 1; wherein said magnet material particles have an average diameter equal to or less than 3 μm.

4. A rare-earth magnet-forming sintered body in accordance with claim 1; wherein the three dimensional shape is of a configuration having a cross section perpendicular to the lengthwise direction of a trapezoidal shape.

5. A rare-earth magnet-forming sintered body in accordance with claim 1; wherein the three dimensional shape is of a configuration having a cross section perpendicular to the lengthwise direction of an arcuate shape wherein the first and second surfaces are of annular shape having a common center of arc.

6. A rare-earth sintered magnet obtained by magnetizing a rare-earth magnet-forming sintered body in accordance with claim 1.
